(19) United States
(12) Patent Application Publication
(10) Pub. No.: US 2026/0003257 A1
(43) Pub. Date: Jan. 1, 2026

(54) LIGHT SOURCE DEVICE AND PROJECTOR

(71) Applicant: SEIKO EPSON CORPORATION, Tokyo (JP)

(72) Inventor: Tomohiro YOKOO, MATSUMOTO-SHI (JP)

(21) Appl. No.: 19/245,929

(22) Filed: Jun. 23, 2025

(30) Foreign Application Priority Data
Jun. 26, 2024 (JP) 2024-102916

(51) Int. Cl. G03B 21/20; G03B 33/12

(52) U.S. Cl. CPC G03B 21/204; G03B 21/2013; G03B 21/2066; G03B 33/12

(57) ABSTRACT

A light source device includes a first light source for emitting first light, a first wavelength conversion element for converting the first light into second light, a first optical layer for transmitting the first light and reflecting the second light, a second light source for emitting third light, and a light guide section for guiding the second light and the third light. The first wavelength conversion element has a first surface on which the first light is incident via the first optical layer, and a second surface and a third surface which intersect the first surface and face away from each other. The second light source is disposed in a region on the second surface side of the light guide section. The first optical layer reflects the third light in addition to the second light, and a portion of the second light and the third light travels through the light guide section and is emitted from the region on the third surface side of the light guide section.

The present application is based on, and claims priority from JP Application Serial Number 2024-102916, filed Jun. 26, 2024 the disclosure of which is hereby incorporated by reference herein in its entirety.

### BACKGROUND

### 1. Technical Field

The present disclosure relates to a light source device and a projector.

### 2. Related Art

As a light source device used for a projector, a light source device has been proposed that uses fluorescent light emitted from a phosphor when the phosphor is irradiated with excitation light emitted from a light emitting element. International Publication WO2006/054203 discloses a light source device including a plate-like wavelength conversion member containing a phosphor, and a light emitting diode that emits excitation light. In the light source device, among the plurality of surfaces of the wavelength conversion member, the excitation light is incident from an incidence surface having a large area and the fluorescent light is emitted from an emission surface having a small area.

In the light source device of International Publication WO2006/054203, the fluorescent light generated inside the wavelength conversion member propagates inside the wavelength conversion member by total reflection at the interface between the upper surface of the wavelength conversion member and the air layer, and is emitted from the emission surface. However, a component of the fluorescent light that is incident on the interface between the wavelength conversion member and the air layer at an angle less than the critical angle is not totally reflected by the interface, and thus leaks out from the interface before reaching the emission surface. Therefore, there is a problem in that the utilization efficiency of fluorescent light is reduced.

### SUMMARY

To overcome the above problem, a light source device according to an aspect of the present disclosure includes a first light source configured to emit first light of a first wavelength band; a first wavelength conversion element configured to convert the first light into second light in a second wavelength band different from the first wavelength band of the first light; a first optical layer that is disposed between the first light source and the first wavelength conversion element and that is configured to transmit the first light and reflect the second light; a second light source that emits third light in a third wavelength band different from the second wavelength band; and a light guide section that is disposed between the first wavelength conversion element and the first optical layer and that is configured to guide the second light converted by the first wavelength conversion element and the third light emitted from the second light source, wherein the first wavelength conversion element includes a first surface on which the first light is incident via the first optical layer, and a second surface and a third surface that intersect with the first surface and that face away from each other, the second light source is disposed in a region at a second surface side of the light guide section, the first optical layer reflects the third light emitted from the second light source in addition to reflecting the first light, and a portion of the second light converted by the first wavelength conversion element and of the third light emitted from the second light source travel through the light guide section and are emitted from a region on a third surface side of the light guide section.

Another aspect of the light source device of the disclosure includes a first light source configured to emit first light of a first wavelength band; a first wavelength conversion element configured to convert the first light into second light in a second wavelength band different from the first wavelength band of the first light; a first optical layer that is disposed between the first light source and the first wavelength conversion element and that is configured to transmit the first light and reflect the second light; a light guide section that is disposed on an opposite side than the first optical layer with respect to the first wavelength conversion element and that guides incident light; a second wavelength conversion element that is disposed on an opposite side than the first wavelength conversion element with respect to the light guide section and that converts the first light incident through the first optical layer, the first wavelength conversion element, and the light guide section into a third light having a third wavelength band different from the first wavelength band; a second optical layer that is disposed at an opposite side than the light guide section with respect to the second wavelength conversion element and that reflects the second light and the third light; and a second light source that emits a fourth light having a fourth wavelength band different from the second wavelength band and the third wavelength band, wherein the first wavelength conversion element includes a first surface on which the first light is incident via the first optical layer, and a second surface and a third surface that intersect with the first surface and that face away from each other, the second light source is disposed in a region at a second surface side of the light guide section, the first optical layer and the second optical layer reflect the fourth light emitted from the second light source in addition to reflecting the second light and the third light, and a portion of the second light converted by the first wavelength conversion element, the third light converted by the second wavelength conversion element, and the fourth light emitted from the second light source travels through the light guide section and is emitted from a region at the third surface side of the light guide section.

A projector according to an aspect of the present disclosure includes a light source device according to one aspect of the present disclosure, a light modulation device that modulates the light emitted from the light source device; and a projection optical device that projects the light modulated by the light modulation device.

### BRIEF DESCRIPTION OF THE DRAWINGS

FIG. 1 is a schematic configuration diagram of a projector according to a first embodiment.

FIG. 2 is a perspective view of a light source device of the first embodiment.

FIG. 3 is a cross-sectional view of the light source device taken along line III-III of FIG. 2.

FIG. 4 is a plan view of the light source device of the first embodiment as viewed from a +X side to a −X side.

FIG. 5 is a cross-sectional view of a light source device of a second embodiment.

FIG. 6 is a cross-sectional view of the light source device of the third embodiment.

FIG. 7 is a cross-sectional view of a light source device of a fourth embodiment.

FIG. 8 is a cross-sectional view of the light source device taken along a line VIII-VIII of FIG. 7.

FIG. 9 is a plan view of the light source device of the fourth embodiment as viewed from the +X side to the −X side.

FIG. 10 is a schematic view for explaining the operation of a light source device of a fifth embodiment.

FIG. 11 is a cross-sectional view of a light source device of a sixth embodiment.

FIG. 12 is a cross-sectional view of a light source device of a seventh embodiment.

### DESCRIPTION OF EMBODIMENTS

### First Embodiment

Hereinafter, a first embodiment of the present disclosure will be described with reference to the drawings.

The projector according to the present embodiment is an example of a projector using a liquid crystal panel as a light modulation device.

In each of the following drawings, in order to make each constituent element easy to see, the constituent elements may be shown with different scales of dimensions.

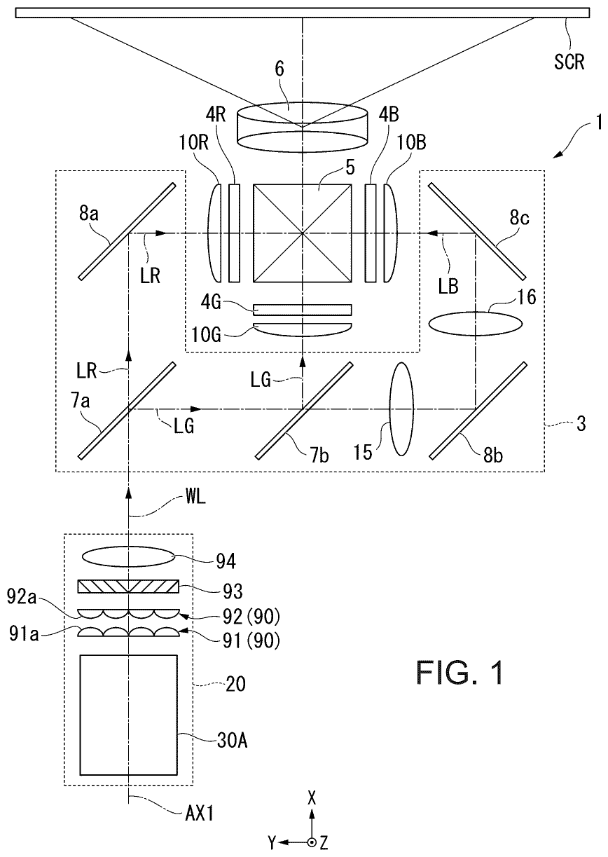

FIG. 1 is a schematic configuration diagram of a projector 1 according to the present embodiment.

As shown in FIG. 1, the projector 1 according to the present embodiment is a projection-type image display device that displays a color image on a screen SCR as a projection surface. The projector 1 includes three light modulation devices corresponding to red light LR, green light LG, and blue light LB.

The projector 1 includes an illumination device 20, a color separation optical system 3, a light modulation device 4R, a light modulation device 4G, a light modulation device 4B, a light combining element 5, and a projection optical device 6.

The illumination device 20 includes a light source device 30A, an integrator optical system 90, a polarization conversion element 93, and a superimposition optical system 94. The illumination device 20 emits white illumination light WL that includes red light LR, green light LG, and blue light LB. Specific configuration of the illumination device 20 will be described later.

In the following description, an XYZ orthogonal coordinate system is used as necessary in the drawings. The X-axis is parallel to the optical axis AX1 of the illumination device 20 and extends in the front-rear direction of the projector 1. The Y-axis is an axis orthogonal to the X-axis, and is an axis along the vertical direction of the projector 1. The Z-axis is an axis orthogonal to the X-axis and the Y-axis, and is an axis along the left-right direction of the projector 1. These notations are for describing the arrangement relationship of the respective constituent members of the projector 1, and do not limit the installation posture or direction of the projector 1. The optical axis AX1 of the illumination device 20 is the central axis of the illumination light WL emitted from the illumination device 20.

One of the two directions along the X-axis is referred to as a +X direction and the opposite direction is referred to as a −X direction, one of the two directions along the Y-axis is referred to as a +Y direction and the opposite direction is referred to as a −Y direction, and one of the two directions along the Z-axis is referred to as a +Z direction and the opposite direction is referred to as a −Z direction.

Two directions along the X-axis are collectively referred to as an X-axis direction when not distinguished from each other, the two directions along the Y-axis are collectively referred to as a Y-axis direction when not distinguished from each other, and the two directions along the Z-axis are collectively referred to as a Z-axis direction when not distinguished from each other.

The color separation optical system 3 includes a first dichroic mirror 7a, a second dichroic mirror 7b, a first reflective mirror 8a, a second reflective mirror 8b, a third reflective mirror 8c, a first relay lens 15, and a second relay lens 16. The color separation optical system 3 separates the illumination light WL emitted from the illumination device 20 into red light LR, green light LG, and blue light LB, guides the red light LR to the light modulation device 4R for red light, guides the green light LG to the light modulation device 4G for green light, and guides the blue light LB to the light modulation device 4B for blue light.

The light modulation device 4R modulates the red light LR in accordance with image information to form image light corresponding to the red light LR. The light modulation device 4G modulates the green light LG in accordance with image information to form image light corresponding to the green light LG. The light modulation device 4B modulates the blue light LB in accordance with image information to form image light corresponding to the blue light LB.

A transmissive liquid crystal panel, for example, is used for each of the light modulation device 4R, light modulation device 4G, and light modulation device 4B. Polarizing plates (not shown) are disposed on the incident side and on the exit side of the liquid crystal panel. The polarizing plates transmit only light that is linearly polarized in a specific direction.

A field lens 10R is disposed on the incident side of the light modulation device 4R. A field lens 10G is disposed on the incident side of the light modulation device 4G. A field lens 10B is disposed on the incident side of the light modulation device 4B. The field lens 10R collimates the principal light rays of the red light LR incident on the light modulation device 4R. The field lens 10G collimates the principal light rays of the green light LG incident on the light modulation device 4G. The field lens 10B collimates the principal light rays of the blue light LB incident on the light modulation device 4B.

By the image light beams emitted from the light modulation device 4R, the light modulation device 4G, and the light modulation device 4B being incident on the light combining element 5, the light combining element 5 combines the image light corresponding to the red light LR, the green light LG, and the blue light LB, and emits the combined image light toward the projection optical device 6. For example, a cross dichroic prism is used as the light combining element 5.

The projection optical device 6 is configured from a plurality of projection lenses. The projection optical device 6 broadens the image light that was combined by the light combining element 5 and projects it toward the screen SCR. By this, a color image is displayed on the screen SCR.

Next, the light source device 30A, which is a main component of the illumination device 20, will be described.

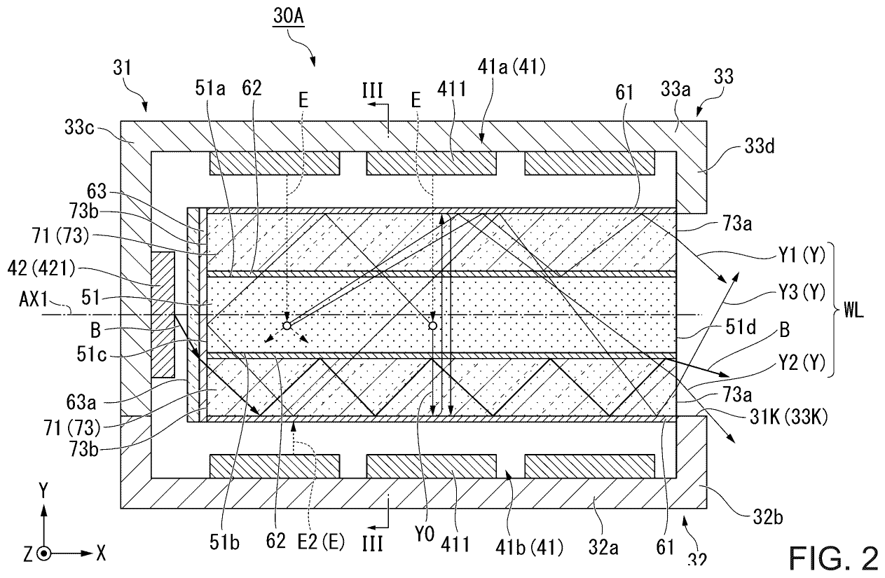

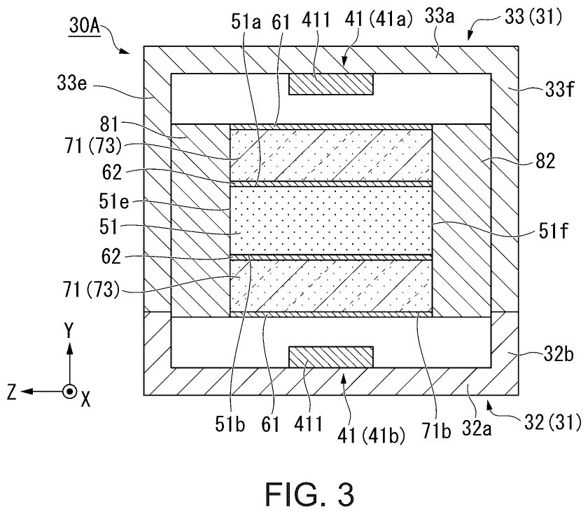

FIG. 2 is a cross-sectional view of the light source device 30A of the present embodiment. FIG. 3 is a cross-sectional view of the light source device 30A taken along line III-III of FIG. 2.

As illustrated in FIGS. 2 and 3, the light source device 30A according to the present embodiment includes a housing 31, a pair of first light sources 41, a first wavelength conversion element 51, a pair of first optical layers 61, a pair of second optical layers 62, a third optical layer 63, a pair of light guide sections 71, a second light source 42, a first reflective member 81, and a second reflective member 82.

The housing 31 forms the exterior of the light source device 30A. The housing 31 accommodates the first light sources 41, the first optical layer 61, the second optical layer 62, the third optical layer 63, the light guide section 71, the first wavelength conversion element 51, the second light source 42, the first reflective member 81, and the second reflective member 82. The housing 31 includes a bottom plate section 32 and a lid body 33. The lid body 33 has a box shape with one surface opened and includes a top wall section 33a, a first side wall section 33c, a second side wall section 33d, a third side wall section 33e, a fourth side wall section 33f, and an opening 33K.

The bottom plate section 32 is disposed along the XZ plane and supports one of the first light sources 41. The bottom plate section 32 includes a base section 32a and a frame section 32b. The base section 32a is a plate-like member forming the main body of the bottom plate section 32 and extends long in the X-axis direction. The frame section 32b is formed integrally with the base section 32a, and is provided on the upper surface of the base section 32a located on the +Y side. The bottom plate section 32 has a recessed portion that accommodates one of the first light sources 41.

The bottom plate section 32 is connected to the first light source 41 in a heat transferable manner. Therefore, it is desirable that the bottom plate section 32 has a predetermined strength and that it is made of a material with high thermal conductivity. Therefore, as the material for the bottom plate section 32, for example, metals such as aluminum or stainless steel are used, and in particular, an aluminum alloy such as the 6061 series is desirably used.

In the lid body 33, the top wall section 33a is disposed along the XZ plane. The first side wall section 33c and the second side wall section 33d intersect the X-axis along the longitudinal direction of the light source device 30A, and are located on opposite sides of each other in the X-axis direction. The first side wall section 33c is located on the −X side, which is one side in the X-axis direction. The second side wall section 33d is located on the +X side, which is the other side in the X-axis direction. The third side wall section 33e and the fourth side wall section 33f are located on opposite sides from each other in the Z-axis direction, which intersects the longitudinal direction of the light source device 30A. In the present embodiment, the third side wall section 33e is positioned on the +Z side, which is to one side in the Z-axis direction. The fourth side wall section 33f is located on the −Z side, which is to the other side in the Z-axis direction.

The top wall section 33a is connected to the first light source 41 in a heat transferable manner. The third side wall section 33e and the fourth side wall section 33f are connected to the first wavelength conversion element 51 and the light guide section 71 in a heat-transferable manner via the first reflective member 81 and the second reflective member 82. Therefore, similarly to the bottom plate section 32, the lid body 33 is preferably made of a material that has a predetermined strength and that has high thermal conductivity. Therefore, as a material for the lid body 33, a metal such as aluminum or stainless steel is used, similar to the bottom plate section, and in particular, an aluminum alloy such as the 6061 series is desirably used.

According to this configuration, since the heat of the first wavelength conversion element 51 and the light guide section 71 is released out via the lid body 33, it is possible to suppress an increase in temperature of the first wavelength conversion element 51 and the light guide section 71. As a result, it is possible to suppress a decrease in wavelength conversion efficiency that accompanies an increase in the temperature of the first wavelength conversion element 51.

The bottom plate section 32 and the lid body 33 are arranged so that their respective side wall sections abut against each other. The lid body 33 and the bottom plate section 32 are fixed to each other via a fixing member such as an adhesive or a screw (not shown). In this way, in the light source device 30A, the components of the first light source 41, the first optical layer 61, the second optical layer 62, the third optical layer 63, the light guide section 71, the first wavelength conversion element 51, the second light source 42, the first reflective member 81, and the second reflective member 82 are accommodated in the space surrounded by the housing 31. By this, adhesion of foreign matter such as dust to the above-described components can be suppressed.

The housing 31 includes an extraction port 31K through which light emitted from the light guide section 71 and the first wavelength conversion element 51 is extracted out. The extraction port 31K is an opening defined by the opening 33K provided in the second side wall section 33d of the lid body 33 and a portion of the frame section 32b of the bottom plate section 32. According to this configuration, the housing 31 can protect the first light source 41, the first optical layer 61, the second optical layer 62, the third optical layer 63, the light guide section 71, the first wavelength conversion element 51, the second light source 42, the first reflective member 81, and the second reflective member 82, as well as extract out the light propagating inside the light guide section 71 as the illumination light WL through the extraction port 31K.

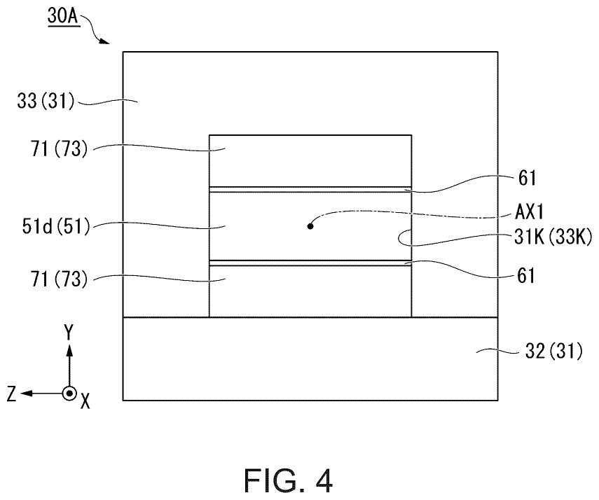

FIG. 4 is a plan view of the light source device 30A as viewed from the +X side to the −X side. That is, FIG. 4 is a plan view of the first wavelength conversion element 51 when viewed in plan in the X-axis direction, which is the normal direction to a second end surface 51d, which is along the YZ plane. As shown in FIG. 4, the extraction port 31K overlaps the light guide section 71 and the first wavelength conversion element 51. In the present embodiment, the extraction port 31K has a shape that exposes the first wavelength conversion element 51, the pair of light guide sections 71, and the pair of second optical layers 62 at the inside and does not expose the pair of first optical layers 61 at the inside. Note that the extraction port 31K may have a shape that exposes the pair of first optical layers 61 at the inside.

The light source device 30A according to the present embodiment can efficiently extract, as the illumination light WL, the white light including the fluorescent light Y and the blue light rays B propagating through the inside of the light guide section 71 and the fluorescent light Y emitted from the first wavelength conversion element 51 via the extraction port 31K of the housing 31.

Note that a configuration may be adopted in which the extraction port 31K is closed by a lid body made of a translucent member, and in which the light guide section 71 is not exposed to the outside.

As shown in FIG. 2, each of the pair of first light sources 41 includes a plurality of first light emitting elements 411. The first light emitting elements 411 constituting one of the first light sources 41 are mounted on the top wall section 33a of the housing 31, and the first light emitting elements 411 constituting the other of the first light sources 41 are mounted on the base section 32a of the housing 31. The number of first light emitting elements 411 included in the first light source is not particularly limited. The first light emitting elements 411 emit excitation light in a first wavelength band. The first light emitting elements 411 are composed of, for example, light emitting diodes (LED). The first light emitting elements 411 are disposed to face the first wavelength conversion element 51 and emit excitation light rays toward the first wavelength conversion element 51. The first wavelength band is an ultraviolet wavelength band, and the center wavelength is, for example, 380 nm. The first light emitting elements 411 are arranged along the X-axis direction, which is the longitudinal direction of the first wavelength conversion element 51. In this way, the first light source 41 emits excitation light E that is in the first wavelength band and that is formed of a plurality of excitation light rays toward the first wavelength conversion element 51. The excitation light E of the present embodiment corresponds to an example of “first light of a first wavelength band” in this disclosure.

The second light source 42 includes one second light emitting element 421. The second light emitting element 421 is mounted on the first side wall section 33c of housing 31. Note that the number of second light emitting elements 421 is not particularly limited. The second light emitting element 421 emits blue light rays in a third wavelength band different from the second wavelength band. The second light emitting element 421 is composed of, for example, an LED. The second light emitting element 421 is disposed so as to face the first end surface 51c of the first wavelength conversion element 51 and the end surface 73b on the first end surface 51c side of the light guide section 71 (the first translucent member 73), and emits blue light rays B toward the first wavelength conversion element 51 and the first translucent member 73. The third wavelength band is a blue wavelength band, and the center wavelength is, for example, 550 nm. The blue light rays B of the present embodiment corresponds to the “third light of the third wavelength band” of the disclosure. In the present embodiment, the second wavelength band of the blue light rays B is larger than the first wavelength band of the excitation light E.

The first wavelength conversion element 51 has a columnar shape extending along the X-axis and has six surfaces. The side of the first wavelength conversion element 51 extending along the X-axis is longer than the side extending along the Y-axis and the side extending along the Z-axis. The X-axis direction corresponds to the longitudinal direction of the first wavelength conversion element 51. The Y-axis direction is a direction parallel to the shortest side amongst the sides of the first wavelength conversion element 51. The length of the side along the Y-axis is shorter than the length of the side along the Z-axis. That is, the cross-sectional shape of the first wavelength conversion element 51 cut along the YZ plane is a rectangular shape as shown in FIG. 3.

The first wavelength conversion element 51 has an upper surface 51a and a lower surface 51b, the first end surface 51c and the second end surface 51d, and a first side surface 51e and a second side surface 51f. The upper surface 51a and the lower surface 51b intersect the Y-axis and face away from each other in the Y-axis. In the present embodiment, the upper surface 51a is a surface located on the +Y side, which is one side in the Y-axis direction. The lower surface 51b is a surface located on the −Y side, which is the other side in the Y-axis direction. The excitation light Es from the first light source 41 that is disposed on the top wall section 33a is incident on the upper surface 51a via the first optical layer 61 and the light guide section 71. The excitation light E from the first light source 41 that is disposed on the base section 32a is incident on the lower surface 51b via the first optical layer 61 and the light guide section 71. The upper surface 51a and the lower surface 51b of the present embodiment correspond to an example of a “first surface” of the present disclosure.

As shown in FIG. 2, the first end surface 51c and the second end surface 51d intersect with the upper surface 51a and the lower surface 51b, and face away from each other in the X-axis direction, which is along the longitudinal direction of the first wavelength conversion element 51. In the present embodiment, the first end surface 51c is located on the −X side, which is one side in the X-axis direction. The second end surface 51d is located on the +X side, which is the opposite side in the X-axis direction. The first end surface 51c of the present embodiment corresponds to an example of the “second surface” of this disclosure, and the second end surface 51d of the present embodiment corresponds to an example of the “third surface” of this disclosure.

As shown in FIG. 3, the first side surface 51e and the second side surface 51f intersect the upper surface 51a and the lower surface 51b, and the first end surface 51c and the second end surface 51d, and face away from each other in the Z-axis direction. In the present embodiment, the first side surface 51e is located on the +Z side, which is one side in the Z-axis direction, and the second side surface 51f is located on the −Z side, which is the other side in the Z-axis direction. The first side surface 51e of the present embodiment corresponds to an example of a “fourth surface” of this disclosure, and the second side surface 51f of the present embodiment corresponds to an example of a “fifth surface” of this disclosure.

The first wavelength conversion element 51 includes at least a yellow phosphor and converts the excitation light E, which is in the first wavelength band and which was emitted from the first light source 41, into yellow fluorescent light Y in a second wavelength band that is different from the first wavelength band.

The first wavelength conversion element 51 includes a ceramic phosphor made of a polycrystalline phosphor that converts the wavelength of the excitation light E into the yellow fluorescent light Y. The first wavelength conversion element 51 of the present embodiment is composed of a phosphor that has no light scattering property, namely, a transparent phosphor. The second wavelength band of the fluorescent light Y is, for example, a yellow wavelength band of 490 to 750 nm. The center wavelength of the second wavelength band is, for example, 550 nm. That is, the fluorescent light Y is yellow fluorescent light containing a red light component and a green light component. The yellow fluorescent light Y of the present embodiment corresponds to an example of the “second light” of the present disclosure. That is, in the present embodiment, the second wavelength band of the fluorescent light Y is larger than the third wavelength band of the blue light rays B.

In the present specification, transparent phosphor refers to, for example, a phosphor having a total light transmittance of 80% or more with respect to fluorescent light. Examples of the transparent phosphor constituting the first wavelength conversion element 51 include a transparent single crystal or polycrystal with a total light transmittance of 80% or more, such as a YAG ceramic-based ceramic phosphor obtained by sintering YAG phosphor particles.

The first wavelength conversion element 51 made of such a material converts the excitation light E into yellow fluorescent light Y.

The first optical layer 61 is disposed between the first light source 41 and the first wavelength conversion element 51. To be specific, the first optical layer 61 is disposed between the first wavelength conversion element 51 and the first light source 41 at the bottom plate section 32 side, and between the first wavelength conversion element 51 and the first light source 41 at the top wall section 33a side. The first optical layer 61 has optical characteristics of transmitting the excitation light E and reflecting the yellow fluorescent light Y. The first optical layer 61 reflects the blue light rays B emitted from the second light source 42 in addition to the fluorescent light Y. The first optical layer 61 is configured from, for example, a dielectric multilayer film. The first optical layer 61 is disposed on a surface of the light guide section 71 (to be described later) that faces the first light source 41.

The light guide section 71 is disposed between the first optical layer 61 and the first wavelength conversion element 51. To be specific, the light guide section 71 is disposed between the first wavelength conversion element 51 and the first optical layer 61 that is on the side close to the bottom plate section 32, and between the first wavelength conversion element 51 and the first optical layer 61 that is on the side close to the top wall section 33a. The light guide section 71 guides a portion of the yellow fluorescent light Y converted by the first wavelength conversion element 51 and of the blue light rays B emitted from the second light source 42. In the present embodiment, a first translucent member 73 that transmits the excitation light E and the yellow fluorescent light Y is disposed in the light guide section 71. The first translucent member 73 is bonded by an optical adhesive to the upper surface 51a and the lower surface 51b of the first wavelength conversion element 51.

The first translucent member 73 is configured from a light-transmissive material, such as borosilicate glass (such as BK7), silica, synthetic silica, crystal, SiC, GaN, MgO, YAG, sapphire, or diamond, through which the excitation light E, the fluorescent light Y, and the blue light rays B can pass. The first translucent member 73 has a plate shape extending along the X-axis. As shown in FIG. 3, the first translucent member 73 has a rectangular cross-sectional shape taken along a plane along the YZ plane, and extends along in the X-axis direction.

The thermal conductivity of the first translucent member 73 is preferably higher than the thermal conductivity of the first wavelength conversion element 51. Materials that satisfy this relationship of the first translucent member 73 are, for example, SiC, GaN, MgO, YAG, sapphire, diamond, or the like. According to this configuration, since the heat of the first wavelength conversion element 51 is efficiently transmitted to the first translucent member 73, it is possible to suppress temperature rise of the first wavelength conversion element 51. By this, it is possible to suppress a decrease in conversion efficiency that accompanies an increase in the temperature of the first wavelength conversion element 51.

The second optical layer 62 is disposed between the first wavelength conversion element 51 and the light guide section 71. To be specific, the second optical layer 62 is disposed between the first wavelength conversion element 51 and the light guide section 71 on the bottom plate section 32 side, and between the first wavelength conversion element 51 and the light guide section 71 on the top wall section 33a side. In the case of the present embodiment, the second optical layer 62 is provided so as to cover the upper surface 51a and the lower surface 51b of the first wavelength conversion element 51. The second optical layer 62 has optical characteristics of transmitting the excitation light E and the fluorescent light Y and reflecting the blue light rays B. The second optical layer 62 is composed of, for example, a dielectric multilayer film.

As shown in FIG. 2, the third optical layer 63 is disposed on the −X side of the first light source 41, the first optical layer 61, the light guide section 71, the first wavelength conversion element 51, and the second optical layer 62, and on the +X side of the second light source 42. The third optical layer 63 transmits the blue light rays B emitted from the second light source 42 and reflects the fluorescent light Y. Specifically, the third optical layer 63 reflects the fluorescent light Y that propagated inside the light guide section 71 and the first wavelength conversion element 51 and that reached the third optical layer 63. The third optical layer 63 is configured from, for example, a dielectric multilayer film.

In the case of the present embodiment, the third optical layer 63 is provided, via the translucent substrate 63a, on the first end surface 51c of the first wavelength conversion element 51 and on the end surface 73b at the first end surface 51c side of the first translucent member 73 configuring the light guide section 71. The translucent substrate 63a is made of the same material as the first translucent member 73.

As shown in FIG. 3, the first reflective member 81 is disposed on the third side wall section 33e of the housing 31 so as to face the first side surface 51e of the first wavelength conversion element 51 and a region at the first side surface 51e side of the light guide section 71. The second reflective member 82 is disposed on the fourth side wall section 33f of the housing 31 so as to face the second side surface 51f of the first wavelength conversion element 51 and a region at the second side surface 51f side of the light guide section 71.

The first reflective member 81 reflects the fluorescent light Y and the excitation light E. Therefore, for example, the first reflective member 81 reflects the excitation light E that passed through the first wavelength conversion element 51 or the light guide section 71 and that reached the first reflective member 81, so that it falls incident on the first wavelength conversion element 51. By this, the conversion efficiency from the excitation light E to the fluorescent light Y can be enhanced.

Furthermore, the first reflective member 81 reflects, and returns back inside, the fluorescent light Y that was emitted from the first wavelength conversion element 51, that entered the light guide section 71, and that reached the first reflective member 81, and the fluorescent light Y that was guided through the inside of the first wavelength conversion element 51 and that reached the first reflective member 81. By this, loss of the fluorescent light Y can be suppressed.

Similarly, the second reflective member 82 reflects the fluorescent light Y and the excitation light E. The operation and effect of the second reflective member 82 are the same as the operation and effect of the first reflective member 81 described above. The first reflective member 81 and the second reflective member 82 are configured from, for example, a metal film, a dielectric multilayer film, a scattering member, or the like.

As shown in FIG. 1, the integrator optical system 90 is provided on the light exit side of the light source device 30A. The integrator optical system 90 includes a first lens array 91 and a second lens array 92. The integrator optical system 90 functions together with the superimposition optical system 94 as an equalizing illumination optical system that equalizes the intensity distribution of the illumination light WL emitted from the light source device 30A in each of the light modulation devices 4R, 4G, and 4B, which are regions to be illuminated.

The first lens array 91 includes a plurality of first lenses 91a. The first lenses 91a are arranged in a matrix in a plane parallel to the YZ plane, which is orthogonal to the optical axis AX1 of the illumination device 20. The first lenses 91a divide the illumination light WL emitted from the light source device 30A into plural partial luminous fluxes. The shape of each of the first lenses 91a is a rectangular shape substantially similar to the shape of the image forming region of each of the light modulation devices 4R, 4G, and 4B. By this, each of the partial luminous fluxes emitted from the first lens array 91 is efficiently incident on the image forming region of each of the light modulation devices 4R, 4G, and 4B.

The illumination light WL emitted from the first lens array 91 travels toward the second lens array 92. The second lens array 92 is disposed to face the first lens array 91. The second lens array 92 includes a plurality of second lenses 92a corresponding to the plurality of first lenses 91a of the first lens array 91. Together with the superimposition optical system 94, the second lens array 92 forms the images of the plurality of first lenses 91a of the first lens array 91 in the vicinity of the image forming regions of the light modulation devices 4R, 4G, and 4B. The second lenses 92a are arranged in a matrix in a plane parallel to the YZ plane, which is orthogonal to the optical axis AX1 of the illumination device 20. The superimposition optical system 94 is composed of a single convex lens.

In the present embodiment, the first lenses 91a of the first lens array 91 and the second lenses 92a of the second lens array 92 have the same size, but may have different sizes. In the present embodiment, the first lenses 91a of the first lens array 91 and the second lenses 92a of the second lens array 92 are positioned such that their optical axes align with each other, but they may also be positioned in a state where they are eccentric to each other.

The polarization conversion element 93 converts the polarization direction of the illumination light WL emitted from the second lens array 92. Specifically, the polarization conversion element 93 converts, into linearly polarized light, each of the partial luminous fluxes of the illumination light WL divided by the first lens array 91 and emitted from the second lens array 92. The polarization conversion element 93 includes a polarization separation layer, a reflection layer, and a retardation layer (none of which are shown). The polarization separation layer transmits one of the linearly polarized light components included in the illumination light WL emitted from the light source device 30A as is, and reflects the other of the linearly polarized light components in a direction perpendicular to the optical axis AX1. The reflection layer reflects the other linearly polarized component that was reflected by the polarization separation layer in a direction parallel to the optical axis AX1. The retardation layer converts the other linearly polarized light component that was reflected by the reflection layer into the one linearly polarized light component.

Hereinafter, the behavior of light in the light source device 30A of the present embodiment will be described.

As shown in FIG. 2, in the light source device 30A, the excitation light E emitted from one of the first light sources 41 disposed on the +Y side is transmitted through the first optical layer 61, the light guide section 71 (the first translucent member 73), and the second optical layer 62, and is incident on the upper surface 51a of the first wavelength conversion element 51. When the excitation light E enters the first wavelength conversion element 51, the phosphor included inside the first wavelength conversion element 51 is excited, and fluorescent light Y is emitted in various directions from an arbitrary light emitting point.

The fluorescent light Y that is incident on the upper surface 51a and on the lower surface 51b of the first wavelength conversion element 51 at an incident angle less than the critical angle is emitted from the first wavelength conversion element 51, passes through the second optical layer 62, and is incident on the light guide section 71. The fluorescent light Y incident on the light guide section 71 travels inside the first translucent member 73, is reflected by the first optical layer 61, and is again incident on the first wavelength conversion element 51. For example, the fluorescent light Y1 propagates through the inside of the first translucent member 73 while repeatedly being reflected by the first optical layer 61 and reflected by the upper surface 51a of the first wavelength conversion element 51, and is emitted out from the end surface 73a on the second end surface 51d side of the first translucent member 73. Although not shown in the drawings, a portion of the fluorescent light Y emitted from the lower surface 51b of the first wavelength conversion element 51 propagates inside the first t translucent member 73 while repeatedly being reflected by the first optical layer 61 and being reflected by the lower surface 51b of the first wavelength conversion element 51, and is emitted out from the end surface 73a on the second end surface 51d side of the first translucent member 73.

The fluorescent light Y2 is reflected by the first optical layer 61 and is again incident on the first wavelength conversion element 51. In the case of the present embodiment, since the first wavelength conversion element 51 is made of a transparent phosphor, the fluorescent light Y2 is not scattered inside the first wavelength conversion element 51, and the traveling direction of the fluorescent light Y2 does not change inside the first wavelength conversion element 51. Therefore, the fluorescent light Y2 is incident on the light guide section 71 from the lower surface 51b of the first wavelength conversion element 51, and is emitted from a region on the second end surface 51d side of the light guide section 71.

Here, of the fluorescent light Y emitted from the first wavelength conversion element 51, fluorescent light Y0 that is incident perpendicularly on the first optical layer 61 is reflected repeatedly between the pair of first optical layers 61 because the traveling direction of the fluorescent light does not change inside the first wavelength conversion element 51, which is formed of the transparent phosphor.

The fluorescent light Y that is incident on the upper surface 51a and the lower surface 51b of the first wavelength conversion element 51 at an incident angle equal to or larger than the critical angle is totally reflected by the upper surface 51a and the lower surface 51b of the first wavelength conversion element 51. In the present embodiment, since the first wavelength conversion element 51 is configured from a transparent phosphor and the traveling direction of the fluorescent light Y does not change inside the first wavelength conversion element 51, the incident angle of the fluorescent light Y with respect to the upper surface 51a and the lower surface 51b of the first wavelength conversion element 51 also does not change. Therefore, the fluorescent light Y is repeatedly reflected by total reflection inside the first wavelength conversion element 51.

Thus, the fluorescent light Y emitted from the first wavelength conversion element 51 propagates inside the first translucent member 73 or the first wavelength conversion element 51, and is emitted from a region on the second end surface 51d side of the first translucent member 73 or from the second end surface 51d of the first wavelength conversion element 51. In the present embodiment, the end surface 73a on the second end surface 51d side of the first translucent member 73 corresponds to an example of “a region on the third surface side of the light guide section” and “an end surface on the third surface side of the first translucent member” of the present disclosure.

The fluorescent light Y3 that travelled toward the −X side and that reached the third optical layer 63 is reflected by the third optical layer 63, then travels toward the +X side, and follows the same path as the fluorescent light Y1 and Y2 described above. That is, the fluorescent light Y3 propagates through the inside of the first translucent member 73 or the first wavelength conversion element 51, and is emitted from the region on the second end surface 51d side of the first translucent member 73 or the second end surface 51d of the first wavelength conversion element 51.

On the other hand, the blue light rays B emitted from the second light source 42 are incident on the third optical layer 63 via the translucent substrate 63a, are transmitted through the third optical layer 63, and are incident on the first wavelength conversion element 51 and the first translucent member 73. Here, the blue light rays B incident on the first translucent member 73 propagate through the inside of the first translucent member 73 while being repeatedly reflected by the first optical layer 61 and reflected by the second optical layer 62, and are emitted out from the end surface 73a on the second end surface 51d side of the first translucent member 73. Note that a portion of the blue light rays B incident on the first wavelength conversion element 51 is emitted out from the end surface 73a, but another portion is converted into fluorescent light Y.

Therefore, a portion of the blue light rays B emitted from the second light source 42 travel inside the pair of first translucent members 73 and are emitted from the end surface 73a of the light guide section 71 on the second end surface 51d side.

In this way, the light source device 30A according to the present embodiment can emit white illumination light WL, which includes the fluorescent light Y generated by the first wavelength conversion element 51 and the blue light rays B emitted from the second light source 42, out from the extraction port 31K of the housing 31. For this reason, in the light source device 30A, the etendue of the illumination light WL is small, and it is possible to reduce the loss of the illumination light WL in optical members, such as the integrator optical system 90, which are disposed at a subsequent stage after the light source device 30A. As a result, the utilization efficiency of the illumination light WL in the light source device 30A can be improved.

The light source device 30A of the present embodiment can change the ratio between the light amount of the fluorescent light Y and the light amount of the blue light rays B by appropriately adjusting the output of the excitation light E emitted from the first light source 41 and the output of the blue light rays B emitted from the second light source 42. By this, the color temperature of the illumination light WL emitted from the light source device 30A can be adjusted. As a result, it is possible to adjust the color of the image projected from the projector 1.

### Effects of the First Embodiment

The light source device 30A of the present embodiment includes the first light source 41 that emits excitation light E, the first wavelength conversion element 51 that converts the excitation light E into yellow fluorescent light Y, the first optical layer 61 that is disposed between the first light source 41 and the first wavelength conversion element 51 and that transmits the excitation light E and reflects the fluorescent light Y, the second light source 42 that emits blue light rays B in the blue wavelength band that is different from the yellow wavelength band, and a light guide section 71 that is disposed between the first wavelength conversion element 51 and the first optical layer 61 and that guides the fluorescent light Y converted by the first wavelength conversion element 51 and the blue light rays B emitted from the second light source 42. The first wavelength conversion element 51 has an upper surface 51a on which the excitation light E is incident via the first optical layer 61, and a first end surface 51c and a second end surface 51d that intersect the upper surface 51a and that face away from each other. The second light source 42 is disposed in a region at the first end surface 51c side of the light guide section 71. The first optical layer 61 reflects the blue light rays B emitted from the second light source 42 in addition to the fluorescent light Y. A portion of the blue light rays B emitted from the second light source 42 and the fluorescent light Y converted by the first wavelength conversion element 51 travels through the light guide section 71 and is emitted from a region on the second end surface 51d side of the light guide section 71.

As described above, according to the light source device 30A of the present embodiment, a portion of the fluorescent light Y generated by the first wavelength conversion element 51 and of the blue light rays B emitted from the second light source 42 travels through the light guide section 71 and is emitted from the region of the light guide section 71 on the second end surface 51d side. Therefore, for example, compared to a related art light source device in which all the fluorescent light propagates inside the wavelength conversion element, the loss of the fluorescent light Y is small, and the utilization efficiency of the fluorescent light Y can be enhanced. Further, the light source device 30A according to the present embodiment can efficiently emit the white illumination light WL obtained by combining the yellow fluorescent light Y and the blue light rays B.

The projector 1 according to the present embodiment includes the light source device 30A, the light modulation devices 4R, 4G, and 4B that modulate light emitted from the light source device 30A, and the projection optical device 6 that projects the light modulated by the light modulation devices 4R, 4G, and 4B.

According to the projector 1 of the present embodiment, since the illumination device 20 including the light source device 30A that efficiently extracts the illumination light WL including the fluorescent light Y and Y1 is provided, the light use efficiency is excellent.

### Second Embodiment

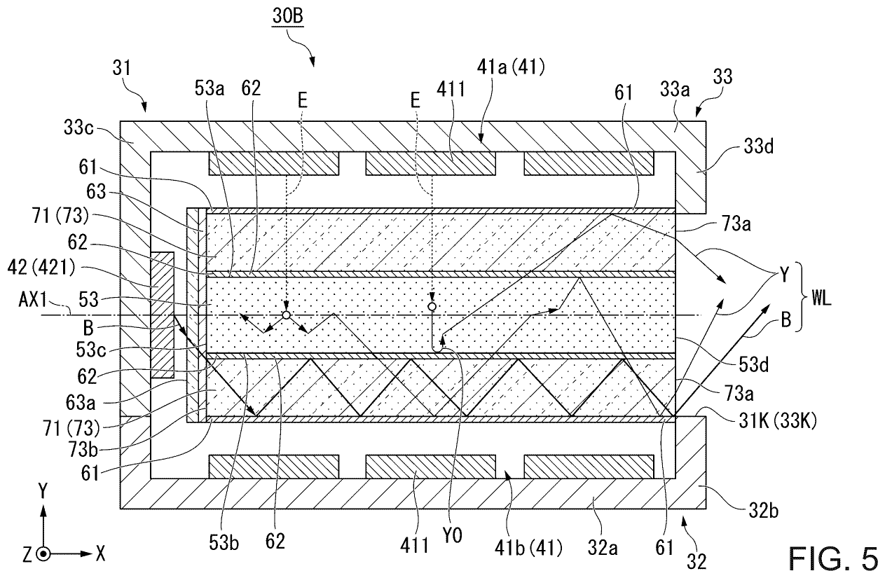

Hereinafter, a second embodiment of the present disclosure will be described with reference to FIG. 5.

Since the basic configuration of the light source device of the second embodiment is the same as the light source device of the first embodiment, the description of the basic configuration will be omitted.

FIG. 5 is a cross-sectional view of a light source device 30B according to the second embodiment cut along the XY plane. In FIG. 5, components common to the drawings used in the first embodiment are denoted by the same reference numerals, and the description thereof will be omitted.

As shown in FIG. 5, the light source device 30B according to the present embodiment includes a housing 31, the pair of first light sources 41, a first wavelength conversion element 53, the pair of first optical layers 61, the pair of second optical layers 62, the third optical layer 63, the pair of light guide sections 71, the second light source 42, a first reflective member (not shown), and a second reflective member (not shown).

In the light source device 30A according to the first embodiment, the first wavelength conversion element 51 is formed of a transparent phosphor. On the other hand, in the light source device 30B according to the present embodiment, the first wavelength conversion element 53 is formed of a phosphor having a light scattering property. The phosphor having a light scattering property can be realized by dispersing, in the transparent phosphor, a medium with a refractive index different from that of the transparent phosphor, for example, scatterers such as pores or fillers. The first wavelength conversion element 53 has an upper surface 53a, a lower surface 53b, a first end surface 53c, and a second end surface 53d. Other configurations of the light source device 30B are the same as those of the light source device 30A of the first embodiment. In the present embodiment, the excitation light E emitted by the first light source 41 corresponds to an example of “first blue light” of the present disclosure, and the blue light rays B emitted by the second light source 42 correspond to an example of “second blue light” of the present disclosure.

### Effects of the Second Embodiment

In the present embodiment also, since the fluorescent light Y propagates through the light guide section 71, it is possible to realize a light source device 30B with minimal loss of the fluorescent light Y and excellent efficiency in the use of the fluorescent light Y, and it is possible to realize a light source device 30B capable of efficiently emitting the illumination light WL, achieving the same effects as those of the first embodiment.

In the case of the first embodiment, since the first wavelength conversion element 51 is composed of a transparent phosphor, the traveling direction of the fluorescent light Y0 (refer to FIG. 2), which, among the fluorescent light Y emitted from the first wavelength conversion element 51, is vertically incident on the first optical layer 61, is less likely to change within the first wavelength conversion element 51, and is repeatedly reflected between the pair of first optical layers 61 without being extracted out, resulting in light loss.

In contrast, in the case of the present embodiment, since the first wavelength conversion element 51 is formed of a phosphor with a light scattering property, then, as shown in FIG. 5, when the fluorescent light Y is incident on the first wavelength conversion element 53, a large amount of scattering occurs, and the traveling direction of the fluorescent light Y changes each time the fluorescent light Y is scattered. Therefore, for example, even if the fluorescent light Y0 is vertically incident on and reflected by the first optical layer 61, it is scattered by the first wavelength conversion element 53 so that its angle changes, and is eventually emitted from the end surface 73a of the first translucent member 73.

In the case of the first embodiment, the fluorescent light confined inside the first wavelength conversion element 51 due to the repetition of total reflection inside the first wavelength conversion element 51 is also scattered inside the first wavelength conversion element 53, and thus the traveling direction of the fluorescent light changes each time the fluorescent light is scattered. Therefore, in the configuration of the first embodiment, the fluorescent light component confined in the first wavelength conversion element 51 can be extracted out from the first wavelength conversion element 51 by angle change due to scattering.

As described above, according to the configuration of the present embodiment, the fluorescent light Y can be emitted from the end surface 73a located in the region on the second end surface 51d side of the first translucent member 73 while being repeatedly scattered by the first wavelength conversion element 53 and reflected by the first optical layer 61. Therefore, according to the light source device 30B of the present embodiment, the fluorescent light Y can be more efficiently extracted as the illumination light WL.

### Third Embodiment

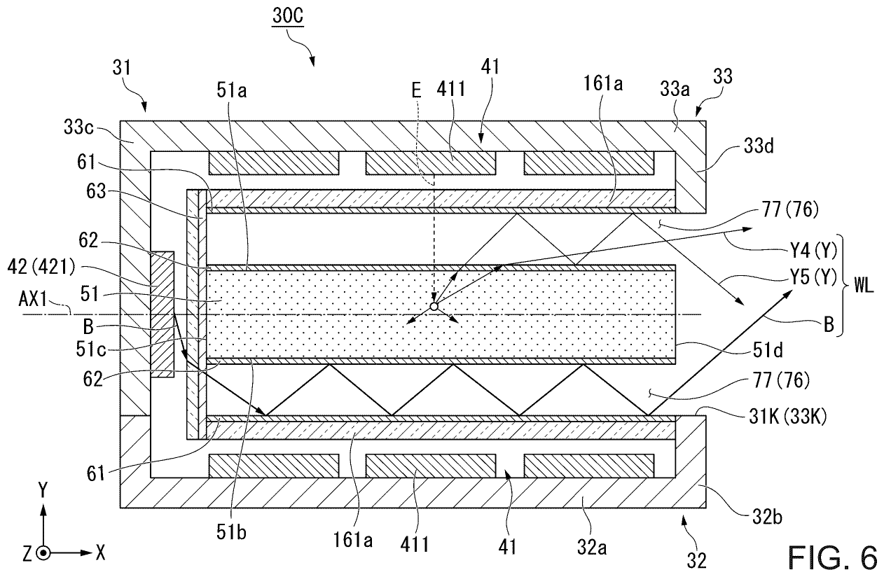

Hereinafter, a third embodiment of the present disclosure will be described with reference to FIG. 6.

Since the basic configuration of the light source device of the third embodiment is the same as light source device of the second embodiment, the description of the basic configuration will be omitted.

FIG. 6 is a cross-sectional view of the light source device 30C according to the third embodiment, cut along the XY plane. In FIG. 6, components common to the drawings used in the second embodiment are denoted by the same reference numerals, and their description will be omitted.

As shown in FIG. 6, a light source device 30C of the present embodiment includes the housing 31, the pair of first light sources 41, the first wavelength conversion element 51, the pair of first optical layers 61, the pair of second optical layers 62, the third optical layer 63, a pair of light guide sections 76, the second light source 42, a first reflective member (not shown), and a second reflective member (not shown).

In the light source device 30C of the present embodiment, each of the pair of light guide sections 76 is formed from an air layer 77. The second optical layer 62 is provided on both the upper surface 51a and the lower surface 51b of the first wavelength conversion element 51. In the present embodiment, the fluorescent light Y converted by the first wavelength conversion element 51 and the blue light rays B emitted from the second light source 42 travel through the air layer 77 and are emitted from a region on the second end surface 51d side of the air layer 77.

In the present embodiment, each first optical layer 61 is provided on a translucent substrate 161a having light transmissivity. The first optical layer 61 is provided on the surface at the first wavelength conversion element 51 side of the translucent substrate 161a. The translucent substrate 161a is made of the same material as the first translucent member 73.

Note that the other configurations of the light source device 30C are the same as those of the light source device 30A of the first embodiment.

Hereinafter, the behavior of light in the light source device 30C of the present embodiment will be described.

As shown in FIG. 6, in the light source device 30C, the excitation light E emitted from the first light source 41 is transmitted through the first optical layer 61 and is incident on the first wavelength conversion element 51.

When the excitation light E enters the first wavelength conversion element 51, the phosphor included inside the first wavelength conversion element 51 is excited, and fluorescent light Y is emitted in various directions from an arbitrary light emitting point.

The fluorescent light Y incident on the upper surface 51a or the lower surface 51b of the first wavelength conversion element 51 at an incident angle less than the critical angle is emitted from the first wavelength conversion element 51, passes through the second optical layer 62, and travels through the air layer 77. For example, the fluorescent light Y4 is directly emitted out from the end surface 73a on the second end surface 51d side of the air layer 77. The fluorescent light Y5 propagates inside the air layer 77 while repeatedly being reflected by the first optical layer 61 and the upper surface 51a of the first wavelength conversion element 51, and is emitted from the region on the second end surface 51d side of the light guide section 76.

The blue light rays B that are emitted from the second light source 42 and that are incident on the light guide section 76 propagate inside the air layer 77 while being repeatedly reflected by the first optical layer 61 and the second optical layer 62, and are emitted out from the end surface 73a on the second end surface 51d side of the air layer 77.

### Effects of the Third Embodiment

In the present embodiment also, since the fluorescent light Y propagates through the light guide section 76, it is possible to realize a light source device 30C with slight loss of the fluorescent light Y and excellent efficiency in use of the fluorescent light Y, and it is possible to realize a light source device 30C capable of efficiently emitting the illumination light WL, achieving the same effects as those of the first embodiment.

In the case of the present embodiment, since the light guide section 76 for guiding the fluorescent light Y and the blue light rays B is formed of the air layer 77, the following effects can be obtained.

In the embodiment, when the air layer 77 serving as the light guide section 76 is adjacent to the first wavelength conversion element 51, the refractive index difference between the first wavelength conversion element 51 and the air layer 77 is about 0.7 because the refractive index of YAG constituting the first wavelength conversion element is about 1.7 and the refractive index of air is about 1.0. On the other hand, for example, in a case where the first translucent member 73 is quartz (refractive index of 1.4), the refractive index difference between the first wavelength conversion element 51 and the light guide section 71 in the case of the first embodiment is approximately 0.3, and the refractive index difference of the present embodiment is larger than the refractive index difference of the first embodiment. Therefore, the fluorescent light Y emitted from the first wavelength conversion element 51 and entering the air layer 77 travels in a direction at a smaller angle with respect to the optical axis AX1 than when entering the first translucent member 73. Therefore, the fluorescent light Y emitted into the air layer 77 travels along the optical axis AX1, making it easily extracted from the extraction port 31K.

In the case of the present embodiment, since the air layer 77 is opened to the external space at the extraction port 31K and there is no refractive index interface, the fluorescent light Y that has reached the extraction port 31K is directly emitted to the external space without being reflected or refracted. According to the light source device 30C of the present embodiment, the extraction efficiency of the fluorescent light Y can be enhanced compared to the first embodiment.

### Fourth Embodiment

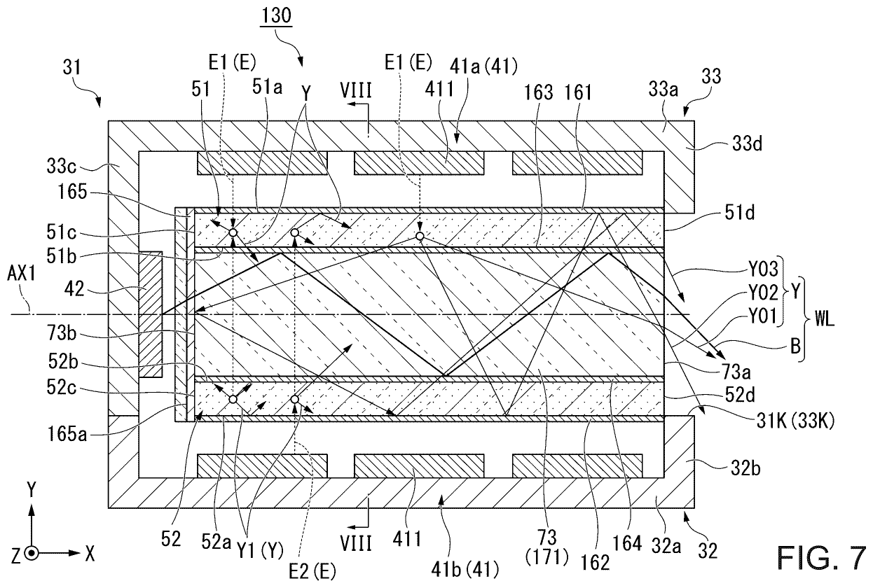

Hereinafter, a light source device according to a fourth embodiment of the present disclosure will be described with reference to FIGS. 7, 8, and 9.

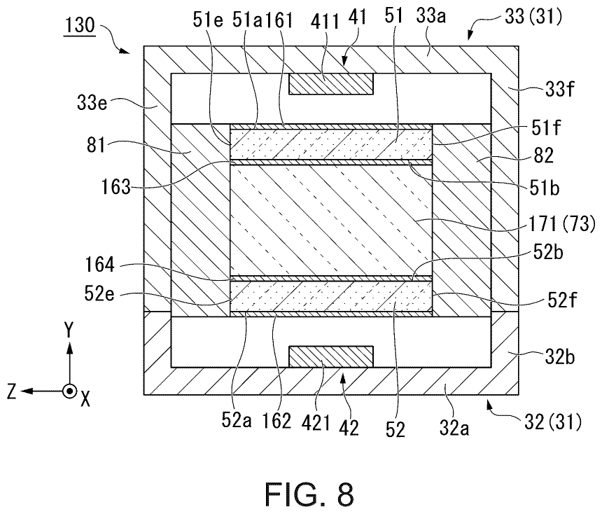

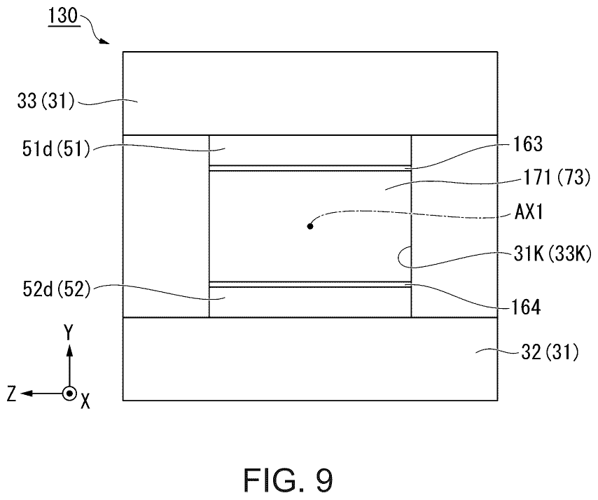

FIG. 7 is a cross-sectional view of a light source device 130 according to the fourth embodiment, cut along the XY plane. FIG. 8 is a cross-sectional view of the light source device 130 taken along the line VIII-VIII in FIG. 7. FIG. 9 is a plan view of the light source device 130 as viewed from the +X side to the −X side. In other words, FIG. 9 is a plan view of the first wavelength conversion element 51 in the X-axis direction, which is the normal direction of the second end surface 51d along the YZ plane. In FIGS. 7, 8, and 9, components common to those in the drawings used in the first embodiment are denoted by the same reference numerals, and their description will be omitted.

As shown in FIGS. 7 and 8, the light source device 130 of the embodiment includes a housing 31, a pair of first light sources 41, a first wavelength conversion element 51, a first optical layer 161, a light guide section 171, a second light source 42, a second wavelength conversion element 52, a second optical layer 162, a third optical layer 163, a fourth optical layer 164, a fifth optical layer 165, a first reflective member 81, and a second reflective member 82. In the light source device 130 according to the present embodiment, the housing 31 includes an extraction port 31K through which the light emitted from the light guide section 171, the first wavelength conversion element 51, and the second wavelength conversion element 52 is extracted out.

As shown in FIG. 9, the extraction port 31K overlaps the light guide section 171, the first wavelength conversion element 51, and the second wavelength conversion element 52. In detail, the extraction port 31K of the present embodiment has a shape that exposes the light guide section 171, the third optical layer 163, the fourth optical layer 164, the first wavelength conversion element 51, and the second wavelength conversion element 52 at the inside, and does not expose the first optical layer 161 and the second optical layer 162 at the inside. The extraction port 31K may have a shape that allows the first optical layer 161 and the second optical layer 162 to be exposed at the inside.

The light source device 130 according to the present embodiment can efficiently extract, as the illumination light WL through the extraction port 31K of the housing 31, the white light including the fluorescent light Y and the blue light rays B propagated inside the light guide section 171, the fluorescent light Y emitted from the first wavelength conversion element 51, and the fluorescent light Y1 emitted from the second wavelength conversion element 52.

As shown in FIG. 7, one first light source 41 emits the excitation light E toward the first wavelength conversion element 51, and the other first light source 41 emits the excitation light E toward the second wavelength conversion element 52. In the following description, one of the pair of first light sources 41 may be referred to as a first light source 41a, the first excitation light E emitted from first light source 41a may be referred to as first excitation light E1, the other of the pair of first light sources 41 may be referred to as a first light source 41b, and the first excitation light E emitted from first light source 41b may be referred to as second excitation light E2.

The first optical layer 161 is disposed between the first light source 41a and the first wavelength conversion element 51. The first optical layer 161 has optical characteristics of transmitting the first excitation light E1 and reflecting the fluorescent light Y. The first optical layer 161 according to the present embodiment reflects the blue light rays B emitted from the second light source 42 in addition to the fluorescent light Y generated by the first wavelength conversion element 51 and the fluorescent light Y1 generated by the second wavelength conversion element 52. The first optical layer 161 is configured from, for example, a dielectric multilayer film. The first optical layer 161 is provided on the surface of the first wavelength conversion element 51 that faces the first light source 41a.

The second wavelength conversion element 52 is disposed on the −Y side of the first wavelength conversion element 51. That is, the second wavelength conversion element 52 is disposed on the opposite side of the light guide section 171 than the first wavelength conversion element 51.

The second wavelength conversion element 52 has a columnar shape extending along the X-axis and has six surfaces. The side of the second wavelength conversion element 52 extending along the X-axis is longer than the sides extending along the Y-axis and the Z-axis. The X-axis direction corresponds to the longitudinal direction of the second wavelength conversion element 52. The Y-axis direction is a direction parallel to the shortest side of the second wavelength conversion element 52. The length of the side along the Y-axis is shorter than the length of the side along the Z-axis. That is, the cross-sectional shape of the second wavelength conversion element 52 cut along the YZ plane is a rectangular shape as shown in FIG. 7.

The second wavelength conversion element 52 has an upper surface 52a and a lower surface 52b, a first end surface 52c and a second end surface 52d, and a first side surface 52e and a second side surface 52f. The upper surface 52a and the lower surface 52b intersect the Y-axis and face away from each other in the Y-axis. In the embodiment, the upper surface 52a is a surface located on the −Y side, which is one side in the Y-axis direction. The lower surface 52b is a surface located on the +Y side, which is the other side in the Y-axis direction.

As shown in FIG. 7, the first end surface 52c and the second end surface 52d intersect with the upper surface 52a and the lower surface 52b, and face away from each other in the X-axis direction, which is along the longitudinal direction of the second wavelength conversion element 52. In the present embodiment, the first end surface 52c is located on the −X side, which is one side in the X-axis direction. The second end surface 52d is located on the +X side, which is the opposite side in the X-axis direction.

As shown in FIG. 8, the first side surface 52e and the second side surface 52f intersect the upper surface 52a and the lower surface 52b, and the first end surface 52c and the second end surface 52d, and face away from each other in the Z-axis direction. In the present embodiment, the first side surface 52e is located on the +Z side, which is one side in the Z-axis direction, and the second side surface 52f is located on the −Z side, which is the other side in the Z-axis direction.

In the present embodiment, the first wavelength conversion element 51 converts the second excitation light E2 that was emitted from the first light source 41b and that was transmitted through the second optical layer 162, the second wavelength conversion element 52, and the light guide section 171, and the first excitation light E1 that was emitted from the first light source 41a and that was transmitted through the first optical layer 161, into yellow fluorescent light Y in the second wavelength band, which is different from the first wavelength band. The first excitation light E1 and the second excitation light E2 of the present embodiment correspond to an example of “first light in a first wavelength band” of the present disclosure, and the yellow fluorescent light Y of the present embodiment corresponds to an example of “second light” of the present disclosure.

The second wavelength conversion element 52 converts the first excitation light E1 that was emitted from the first light source 41a and that was transmitted through the first optical layer 161, the first wavelength conversion element 51, and the light guide section 171, and the second excitation light E2 that was emitted from the first light source 41b and that was transmitted through the second optical layer 162 (to be described later), into yellow fluorescent light Y1 in a third wavelength band, which is different from the first wavelength band. The first excitation light E1 is incident on the lower surface 52b of the second wavelength conversion element 52, and the second excitation light E2 is incident on the upper surface 52a of the second wavelength conversion element 52.

In the present embodiment, the second wavelength conversion element 52 is made of the same material as the first wavelength conversion element 51. Therefore, the third wavelength band of the fluorescent light Y1 is, for example, a yellow wavelength band from 490 to 750 nm, and the center wavelength of the third wavelength band is 550 nm, which is equal to the center wavelength of the second wavelength band. The yellow fluorescent light Y1 of the present embodiment corresponds to an example of the “third light” of the present disclosure.

The second wavelength band and the third wavelength band may be different from other. For example, the center wavelength of the second wavelength band may have a wavelength relatively closer to blue, and the center wavelength of the third wavelength band may have a wavelength relatively closer to green.

The second optical layer 162 is disposed on the opposite side than the light guide section 171 with respect to the second wavelength conversion element 52. The second optical layer 162 is arranged on the opposite side than the light guide section 71 with respect to the second wavelength conversion element 52 and has an optical property of transmitting the second excitation light E2 and reflecting the fluorescent light Y and Y1. The second optical layer 162 of the present embodiment reflects the blue light rays B emitted from the second light source 42 in addition to the fluorescent light Y generated by the first wavelength conversion element 51 and the fluorescent light Y1 generated by the second wavelength conversion element 52. The second optical layer 162 is configured from, for example, a dielectric multilayer film. The second optical layer 162 is provided on a surface of the second wavelength conversion element 52 facing the first light source 41b.

The light guide section 171 is disposed on the opposite side than the first optical layer 161 with respect to the first wavelength conversion element 51 and guides the incident light. Specifically, the light guide section 171 is disposed between the first wavelength conversion element 51 and the second wavelength conversion element 52. The light guide section 171 guides a portion of the fluorescent light Y converted by the first wavelength conversion element 51, the fluorescent light Y1 converted by the second wavelength conversion element 52, and the blue light rays B emitted from the second light source 42. In the case of the present embodiment, the first translucent member 73 that transmits the first t excitation light E1, the second excitation light E2, the fluorescent light Y and Y1, and the blue light rays B is disposed in the light guide section 171.

The third optical layer 163 is disposed between the first wavelength conversion element 51 and the light guide section 171. The fourth optical layer 164 is disposed between the second wavelength conversion element 52 and the light guide section 171. In the present embodiment, the third optical layer 163 is provided on the lower surface 51b of the first wavelength conversion element 51, and the fourth optical layer 164 is provided on the lower surface 52b of the second wavelength conversion element 52. The third optical layer 163 and the fourth optical layer 164 transmit the first excitation light E1, the second excitation light E2, and the fluorescent light Y and Y1, and reflect the blue light rays B. The third optical layer 163 and the fourth optical layer 164 are configured from, for example, a dielectric multilayer film.

In the present embodiment, the second light source 42 emits the blue light rays B toward the first wavelength conversion element 51, the second wavelength conversion element 52, and the first translucent member 73. The blue light rays B of the present embodiment corresponds to the “fourth light of a fourth wavelength band” of the disclosure. In the present embodiment, the fourth wavelength band of the blue light rays B is greater than the first wavelength band of the first excitation light E1 and of the second excitation light E2. The second wavelength band of the fluorescent light Y and the third wavelength band of the fluorescent light Y1 are larger than the fourth wavelength band of the blue light rays B.

As shown in FIG. 7, the fifth optical layer 165 is disposed on the −X side of the first light source 41, the first wavelength conversion element 51, the first optical layer 161, the light guide section 171, the second light source 42, the second wavelength conversion element 52, the second optical layer 162, the third optical layer 163, and the fourth optical layer 164, and on the +X side of the second light source 42. The fifth optical layer 165 transmits the blue light rays B emitted from the second light source 42 and reflects the fluorescent light Y and Y1. To be specific, the fifth optical layer 165 reflects the fluorescent light Y and Y1 that has propagated inside the light guide section 171, the first wavelength conversion element 51, and the second wavelength conversion element 52 and that has reached the fifth optical layer 165. The fifth optical layer 165 is configured from, for example, a dielectric multilayer film.

In the case of the present embodiment, the fifth optical layer 165 is provided, via a translucent substrate 165a, on the end surface 73b on the first end surface 51c side of the first translucent member 73 constituting the light guide section 171, the first end surface 51c of the first wavelength conversion element 51, and the first end surface 52c of the second wavelength conversion element 52. The translucent substrate 165a is made of the same material as the first translucent member 73.

As shown in FIG. 8, the first reflective member 81 is disposed on the third side wall section 33e of the housing 31 so as to face the first side surface 51e of the first wavelength conversion element 51 and a region of the light guide section 171 on the first side surface 51e side. The second reflective member 82 is disposed on the fourth side wall section 33f of the housing 31 so as to face the second side surface 51f of the first wavelength conversion element 51 and a region of the light guide section 171 on the second side surface 51f side.

The first reflective member 81 reflects the first excitation light E1, the second excitation light E2, the fluorescent light Y and Y1, and the blue light rays B. Therefore, the first reflective member 81 reflects, for example, the first excitation light that was transmitted through the first wavelength conversion element 51 or the light guide section 171 and that reached the first reflective member 81 so that it is incident on the first wavelength conversion element 51. By this, the conversion rate from the first excitation light E1 to the fluorescent light Y can be enhanced.

The first reflective member 81 reflects the second excitation light E2 that was transmitted through the second wavelength conversion element 52 or the light guide section 171 and that reached the first reflective member 81 so that it is incident on the second wavelength conversion element 52. By this, the conversion rate from the second excitation light E2 to the fluorescent light Y1 can be enhanced.

Furthermore, the first reflective member 81 reflects, to back inside, the fluorescent light Y that was emitted from the first wavelength conversion element 51, that entered the light guide section 171, and that reached the first reflective member 81, as well as the fluorescent light Y that was guided through the inside of the first wavelength conversion element 51 and that reached the first reflective member 81. By this, loss of the fluorescent light Y can be suppressed.

The first reflective member 81 reflects, back to inside, the fluorescent light Y1 that was emitted from the second wavelength conversion element 52, that was incident on the light guide section 171, and that reached the first reflective member 81, and the fluorescent light Y1 that was guided through the inside of the second wavelength conversion element 52 and that reached the first reflective member 81. By this, loss of fluorescent light Y1 can be suppressed.

Similarly, the second reflective member 82 reflects the first excitation light E1, the second excitation light E2, the fluorescent light Y and Y1, and the blue light rays B. The operation and effects of the second reflective member 82 are the same as the operation and effects of the first reflective member 81 described above. The first reflective member 81 and the second reflective member 82 are configured from, for example, a metal film, a dielectric multilayer film, a scattering member, or the like.

Hereinafter, the behavior of light in the light source device 130 of the present embodiment will be described.

As shown in FIG. 7, in the light source device 130, the first excitation light E1 emitted from the first light source 41a disposed on the +Y side passes through the first optical layer 161 and is incident on the upper surface 51a of the first wavelength conversion element 51. When the first excitation light E1 enters the first wavelength conversion element 51, the phosphor contained in the first wavelength conversion element 51 is excited, and fluorescent light Y is emitted in various directions from an arbitrary light emitting point.

The fluorescent light Y emitted from the first wavelength conversion element 51 is reflected by the first optical layer 161, or is directly incident on the lower surface 51b of the first wavelength conversion element 51 without being reflected by the first optical layer 161. At this time, the fluorescent light Y01 that is incident on the lower surface 51b at an incident angle less than the critical angle is emitted from the first wavelength conversion element 51, passes through the third optical layer 163, is incident on the light guide section 171, and is emitted out from the end surface 73a on the second end surface 51d side of the first translucent member 73.

The fluorescent light Y02 that was emitted from the first wavelength conversion element 51 and that was incident on the lower surface 51b at an incident angle less than the critical angle passes through the first translucent member 73, the fourth optical layer 164, and the second wavelength conversion element 52, is reflected by the second optical layer 162, passes through the first translucent member 73, the third optical layer 163, and the first wavelength conversion element 51 in this order, is reflected again by the first optical layer 161, and is emitted out from the end surface 73a of the first translucent member 73 on the second end surface 51d side. Although not shown in the drawings, a portion of the fluorescent light Y incident on the first translucent member 73 is reflected by the lower surface 52b of the second wavelength conversion element 52, enters the first translucent member 73 again, and is emitted out from the end surface 73a of the first translucent member 73 on the second end surface 51d side.

The fluorescent light Y03 that was emitted from the first wavelength conversion element 51 and that reached the fifth optical layer 165 is reflected by the fifth optical layer 165, then travels toward the +X side, and is reflected by, for example, the first optical layer 161 and the second optical layer 162, thereby propagating through the inside of the first translucent member 73, and is emitted out from the end surface 73a of the first translucent member 73.

In this way, the fluorescent light Y emitted from the first wavelength conversion element 51 propagates inside the first translucent member 73 by being repeatedly reflected between the first wavelength conversion element 51 or the first optical layer 161 and the second wavelength conversion element 52 or the second optical layer 162, and is emitted out from the second end surface 51d on the end surface 73a side of the first translucent member 73. In the present embodiment, the end surface 73a on the second end surface 51d side of the first translucent member 73 corresponds to an example of “a region on the third surface side of the light guide section” and “an end surface on the third surface side of the first translucent member” of the present disclosure.

On the other hand, the second excitation light E2 emitted from the second light source 42 is transmitted through the second optical layer 162 and is incident on the second wavelength conversion element 52. When the second excitation light E2 enters the second wavelength conversion element 52, the phosphor contained inside the second wavelength conversion element 52 is excited, and fluorescent light Y1 is generated at an arbitrary light-emitting point. Note that since the behavior of the fluorescent light Y1 is the same as that of the fluorescent light Y, a detailed description thereof will be omitted.

Therefore, in the light source device 130 according to the present embodiment, the fluorescent light Y converted by the first wavelength conversion element 51 and the fluorescent light Y1 converted by the second wavelength conversion element 52 travel through the light guide section 171 and are emitted from the end surface 73a of the first translucent member 73. Therefore, according to the light source device 30A of the present embodiment, the illumination light WL including the fluorescent light Y and Y1 can be efficiently extracted out from the extraction port 31K of the housing 31.

On the other hand, the blue light rays B emitted from the second light source 42 are incident on the fifth optical layer 165 via the translucent substrate 165a, pass through the fifth optical layer 165, and are incident on the first wavelength conversion element 51, the second wavelength conversion element 52, and the first translucent member 73.

Here, the blue light rays B incident on the first translucent member 73 propagate through the inside of the first translucent member 73 while being repeatedly reflected by the third optical layer 163 and the fourth optical layer 164, and are emitted out from the end surface 73a on the second end surface 51d side of the first translucent member 73. Note that a portion of the blue light rays B incident on the first wavelength conversion element 51 is converted into fluorescent light Y while propagating through the inside of the first wavelength conversion element 51 while being repeatedly reflected by the first optical layer 161 and the third optical layer 163. Similarly, a portion of the blue light rays B incident on the second wavelength conversion element 52 is converted into fluorescent light Y1 while propagating through the inside of the second wavelength conversion element 52 while being repeatedly reflected by the second optical layer 162 and the fourth optical layer 164.

Therefore, a portion of the blue light rays B emitted from the second light source 42 travels inside the first translucent member 73 and is emitted from a region on the second end surface 52d side of the light guide section 171.

### Effects of the Fourth Embodiment

The light source device 130 of the present embodiment includes the first light source 41, which emits excitation light E, the first wavelength conversion element 51, which converts the excitation light E into yellow fluorescent light Y, and the first optical layer 161, which is disposed between the first light source 41 and the first wavelength conversion element 51 and which transmits the excitation light E and reflects the yellow fluorescent light Y, the light guide section 171, which is disposed on the opposite side than the first optical layer 161 with respect to the first wavelength conversion element 51 and which guides incident light, the second wavelength conversion element 52, which is disposed on the opposite side than the first wavelength conversion element 51 with respect to the light guide section 171 and which converts the excitation light E that was incident via the first optical layer 161, the first wavelength conversion element 51, and the light guide section 171 into yellow fluorescent light Y1, the second optical layer 162, which is disposed on the opposite side than the light guide section 171 with respect to the second wavelength conversion element 52 and which reflects the fluorescent light Y and fluorescent light Y1, and the second light source 42, which emits blue light rays B. The first wavelength conversion element 51 has the upper surface 51a on which the excitation light E is incident via the first optical layer 161, and the first end surface 51c and the second end surface 51d, which intersect with the upper surface 51a and which face away from each other. The second light source 42 is disposed in a region on the second end surface 51d side of the light guide section 171, and the first optical layer 161 and the second optical layer 162 reflect the blue light rays B emitted from the second light source 42 in addition to the fluorescent light Y and the fluorescent light Y1. A portion of the fluorescent light Y converted by the first wavelength conversion element 51, the fluorescent light Y1 converted by the second wavelength conversion element 52, and the blue light rays B emitted from the second light source 42 travels through the light guide section 71 and is emitted from a region on the second end surface 51d side of the light guide section 71.

According to the light source device 130 of the present embodiment, the fluorescent light Y generated by the first conversion element 51, the fluorescent light Y1 generated by the second wavelength conversion element 52, and the blue light rays B emitted from the second light source 42 travel through the light guide section 171 and are emitted from the region on the second end surface 52d side of the light guide section 171. Therefore, the loss of the fluorescent light Y and Y1 is small, and the utilization efficiency of the fluorescent light Y and Y1 can be enhanced, for example, as compared with a related art light source device in which all the fluorescent light propagates inside the wavelength conversion element. Further, the light source device 130 according to the present embodiment can efficiently emit the white illumination light WL obtained by combining the yellow fluorescent light Y and Y1 with the blue light rays B.

### Fifth Embodiment

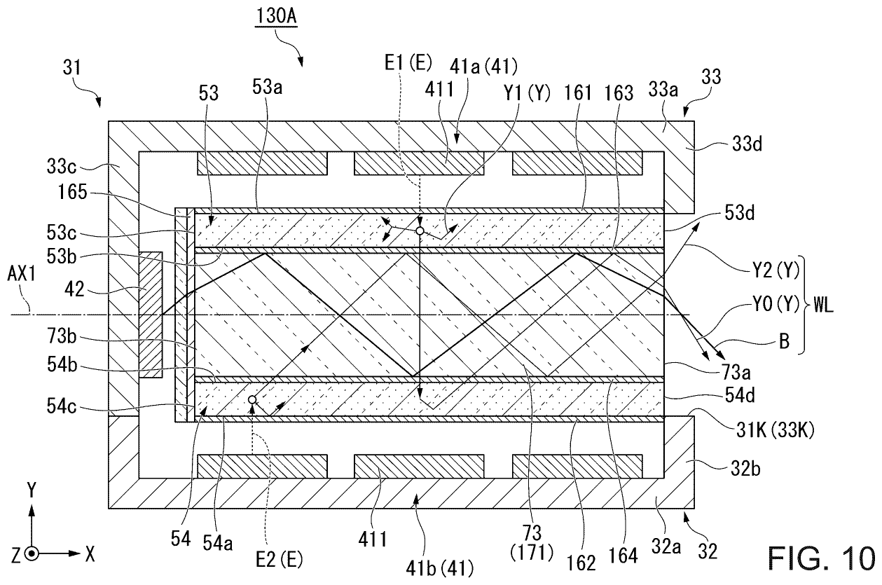

Hereinafter, a fifth embodiment of the present disclosure will be described with reference to FIG. 10.

Since the basic configuration of the light source device of the fifth embodiment is the same as the light source device of the fourth embodiment, the description of the basic configuration will be omitted.

FIG. 10 is a cross-sectional view of a light source device 130A according to the fifth embodiment, cut along the XY plane. In FIG. 10, components common to those in the drawings used in the fourth embodiment are denoted by the same reference numerals, and their description will be omitted.

As shown in FIG. 10, the light source device 130A of the present embodiment includes the housing 31, the pair of first light sources 41, a first wavelength conversion element 53, the first optical layer 161, the light guide section 171, the second light source 42, a second wavelength conversion element 54, the second optical layer 162, the third optical layer 163, the fourth optical layer 164, the fifth optical layer 165, a first reflective member (not shown), and a second reflective member (not shown).

In the light source device 130 according to the fourth embodiment, the first wavelength conversion element 51 and the second wavelength conversion element 52 are made of a transparent phosphor. In contrast, the light source device 130A according to the present embodiment includes a first wavelength conversion element 53 and a second wavelength conversion element 54 made of a phosphor having a light scattering property, as in light source device 30B according to the second embodiment. Other configurations of the light source device 130A are the same as those of the light source device 130 of the fourth embodiment. In the present embodiment, the first excitation light E1 emitted by the first light source 41a and the second excitation light E2 emitted by the first light source 41b correspond to an example of “first blue light” of the present disclosure, and the blue light rays B emitted by the second light source 42 correspond to an example of “second blue light” of the present disclosure.

### Effects of the Fifth Embodiment

In the present embodiment also, the fluorescent light Y and Y1 propagates through the light guide section 171, thus enabling realization of the light source device 130A with minimal loss of the fluorescent light Y and Y1 and excellent utilization efficiency of the fluorescent light Y and Y1, as well as the realization of the light source device 130A capable of efficiently emitting the illumination light WL, achieving the same effects as those of the fourth embodiment.

In the case of the fourth embodiment, since the first wavelength conversion element 51 and the second wavelength conversion element 52 are made of a transparent phosphor, the direction of the fluorescent light that is perpendicularly incident on the first optical layer 161 is less likely to change within the first wavelength conversion element 51 and the second wavelength conversion element 52, and the fluorescent light is repeatedly reflected between the first optical layer 161 and the second optical layer 162, resulting in loss. The same applies to the fluorescent light Y1 emitted from the second wavelength conversion element 52.

In contrast, in the case of the present embodiment, since the first wavelength conversion element 53 and the second wavelength conversion element 54 are formed of a phosphor with a light scattering property, a large amount of scattering occurs when the fluorescent light Y is incident on the first wavelength conversion element 53 or the second wavelength conversion element 52, and the traveling direction of the fluorescent light Y changes each time the fluorescent light Y is scattered. Therefore, for example, even though the fluorescent light Y0 is emitted in the direction perpendicular to the first optical layer 61, it is scattered by the second wavelength conversion element 54 so that its angle changes, and is eventually emitted from the end surface 73a of the first translucent member 73.

In the configuration of the fourth embodiment, the fluorescent light Y and Y1 confined in the first wavelength conversion element 51 or the second wavelength conversion element 52 by being totally reflected repeatedly in the first wavelength conversion element 51 and the second wavelength conversion element 52 is also greatly scattered in the wavelength conversion elements 53 and 54, and the traveling directions of the fluorescent light Y and Y1 can be changed each time the fluorescent light is scattered. In this way, the fluorescent light Y and Y1 propagates through the light guide section 171 while repeating at least one of being scattered by the first wavelength conversion element 53, being reflected by the first optical layer 161, being scattered by the second wavelength conversion element 54, and being reflected by the second optical layer 162, and is emitted from the region on the second end surface 51d side of the light guide section 171. The blue light rays B emitted from the second light source 42 propagate through the light guide section 171 while repeatedly being reflected by the third optical layer 163 and reflected by the fourth optical layer 164, and are emitted from a region on the second end surface 51d side of the light guide section 171.

Therefore, according to the light source device 130A of the present embodiment, the fluorescent light Y and Y1 can be more efficiently extracted as the illumination light WL.

### Sixth Embodiment

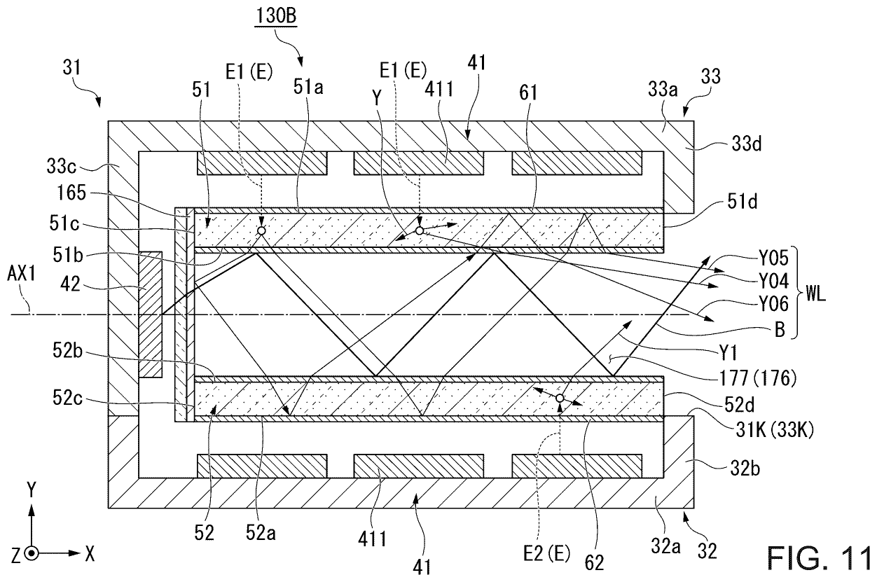

Hereinafter, a sixth embodiment of the present disclosure will be described with reference to FIG. 11.

Since the basic configuration of the light source device of the sixth embodiment is the same as the light source device of the fourth embodiment, the description of the basic configuration will be omitted.

FIG. 11 is a cross-sectional view of the light source device 130B according to the sixth embodiment, cut along the XY plane. In FIG. 11, components common to those in the drawings used in the fourth embodiment are denoted by the same reference numerals, and their description will be omitted.

As shown in FIG. 11, the light source device 130B according to the present embodiment includes the housing 31, the pair of first light sources 41, the first wavelength conversion element 51, the first optical layer 161, a light guide section 176, the second light source 42, the second wavelength conversion element 52, the second optical layer 162, the third optical layer 163, the fourth optical layer 164, the fifth optical layer 165, a first reflective member (not shown), and a second reflective member (not shown).

The light guide section 176 is formed by an air layer 177. That is, the first wavelength conversion element 51 and the second wavelength conversion element 52 are arranged to be separated from each other, and there is air between the first wavelength conversion element 51 and the second wavelength conversion element 52. The light guide section 176 guides the fluorescent light Y converted by the first wavelength conversion element 51 and the fluorescent light Y1 converted by the second wavelength conversion element 52. The second wavelength conversion element 52 is disposed on the opposite side of the first wavelength conversion element 51 than the first light source 41. The second light source 42 is disposed in a region on the first end surface 51c side of the light guide section 176. Other configurations of the light source device 130B are the same as those of the light source device 130 of the fourth embodiment.

Hereinafter, the behavior of light in the light source device 130B of the present embodiment will be described.

As shown in FIG. 11, in the light source device 130B, the first excitation light E1 emitted from the first light source 41a passes through the first optical layer 61 and is incident on the first wavelength conversion element 51.

When the first excitation light E1 enters the first wavelength conversion element 51, the phosphor contained in the first wavelength conversion element 51 is excited, and fluorescent light Y is emitted in various directions from an arbitrary light emitting point.

The fluorescent light Y04 incident on the lower surface 51b of the first wavelength conversion element 51 at an incident angle less than the critical angle is emitted from the first wavelength conversion element 51, travels through the air layer 177, and is then emitted out from a region of the air layer 177 on the second end surface 51d side.

Note that the fluorescent light Y incident on the lower surface 51b of the first wavelength conversion element 51 at an incident angle equal to or larger than the critical angle does not change its traveling direction when passing through the first wavelength conversion element 51 made of a transparent phosphor, and therefore the fluorescent light Y is absorbed by the phosphor and lost while propagating inside the first wavelength conversion element 51 while repeating total internal reflection at the lower surface 51b of the first wavelength conversion element 51 and reflection at the first optical layer 61 and the first reflective member 81.

The fluorescent light Y05 that was emitted from the first wavelength conversion element 51, that traveled through the air layer 177 toward the +X side, transmitted through the fourth optical layer 164, and that was incident on the second wavelength conversion element 52 travels through the air layer 177 while being repeatedly reflected by the second optical layer 62 and the first optical layer 61, and is then emitted out from the region of the air layer 177 on the second end surface 51d side.

The fluorescent light Y06 that was emitted from the first wavelength conversion element 51, that traveled through the air layer 177 towards the −X side, and that was incident on the fifth optical layer 165 is reflected by the fifth optical layer 165, travels through the air layer 177 while being repeatedly reflected by the second optical layer 62 and the first optical layer 61, and is then emitted out from the region of the air layer 177 on the second end surface 51d side.

On the other hand, the second excitation light E2 emitted from the second light source 42 is transmitted through the second optical layer 62 and is incident on the second wavelength conversion element 52. When the second excitation light E2 enters the second wavelength conversion element 52, the phosphor contained inside the second wavelength conversion element 52 is excited, and fluorescent light Y1 is generated at an arbitrary light-emitting point.

On the other hand, the second excitation light E2 emitted from the second light source 42 is transmitted through the second optical layer 62 and is incident on the second wavelength conversion element 52. When the second excitation light E2 enters the second wavelength conversion element 52, the phosphor contained inside the second wavelength conversion element 52 is excited, and fluorescent light Y1 is generated at an arbitrary light-emitting point. Note that since the behavior of the fluorescent light Y1 is the same as that of the fluorescent light Y, a detailed description thereof will be omitted.

Therefore, in the light source device 130B according to the present embodiment, the fluorescent light Y converted by the first wavelength conversion element 51 and the fluorescent light Y1 converted by the second wavelength conversion element 52 travels through the air layer 177 of the light guide section 176 and is emitted from the end surface 73a of the first translucent member 73. Therefore, according to the light source device 130B of the present embodiment, the illumination light WL including the fluorescent light Y and Y1 can be efficiently extracted out from the extraction port 31K of the housing 31.

On the other hand, the blue light rays B emitted from the second light source 42 are incident on the fifth optical layer 165 via the translucent substrate 165a, are transmitted through the fifth optical layer 165, and are incident on the first wavelength conversion element 51, the second wavelength conversion element 52, and the air layer 177.

### Effects of the Sixth Embodiment

In the present embodiment also, the fluorescent light Y and Y1 propagates through the light guide section 176, and thus it is possible to obtain the same effects as those of the fourth embodiment, that is, it is possible to realize the light source device 130B with little loss of the fluorescent light Y and Y1 and excellent utilization efficiency of the fluorescent light Y and Y1, and it is possible to realize the light source device 130B in which the illumination light WL can be efficiently emitted.

In the case of the present embodiment, since the light guide section 176 that guides the fluorescent light Y, Y1, and the blue light rays B is formed from the air layer 177, the following effects can be obtained.

As in the embodiment, when the air layer 177 as the light guide section 176 is adjacent to the first wavelength conversion element 51 and the second wavelength conversion element 52, since the refractive index of YAG, which constitutes the wavelength conversion element, is about 1.7 and the refractive index of air is about 1.0, the refractive index difference between the first wavelength conversion element 51 and the air layer 177 is about 0.7. On the other hand, for example, in a case where the first translucent member 73 is quartz (refractive index of 1.4), the refractive index difference between the first wavelength conversion element 51 and the light guide section 71 in the case of the fourth embodiment is approximately 0.3, and the refractive index difference of the embodiment is larger than the refractive index difference of the fourth embodiment. Therefore, the fluorescent light Y emitted from the first wavelength conversion element 51 and entering the air layer 177 travels in a direction at a smaller angle with respect to the optical axis AX1 than when entering the first translucent member 73. Therefore, the fluorescent light Y emitted to the air layer 177 travels along the optical axis AX1 and is easily extracted from the extraction port 31K.

In the case of the present embodiment, since the air layer 177 is released to the external space at the extraction port 31K and there is no refractive index interface, the fluorescent light Y and Y1 that reached the extraction port 31K is directly emitted to the external space without being reflected or refracted. According to the light source device 130B of the present embodiment, the extraction efficiencies of the fluorescent light Y and Y1 can be further increased as compared with the fourth embodiment by the above-described action.

In the present embodiment, the first wavelength conversion element 51 and the second wavelength conversion element 52 may be replaced with a first wavelength conversion element 53 and a second wavelength conversion element 54, which are composed of a phosphor with a light scattering property. According to this configuration, it is possible to more efficiently extract the fluorescent light Y and Y1 by changing the traveling direction of the fluorescent light Y and Y1 by scattering.

### Seventh Embodiment

Hereinafter, a seventh embodiment of the present disclosure will be described with reference to FIG. 11.

Since the basic configuration of the light source device of the seventh embodiment is the same as the light source device of the fifth embodiment, the description of the basic configuration will be omitted.

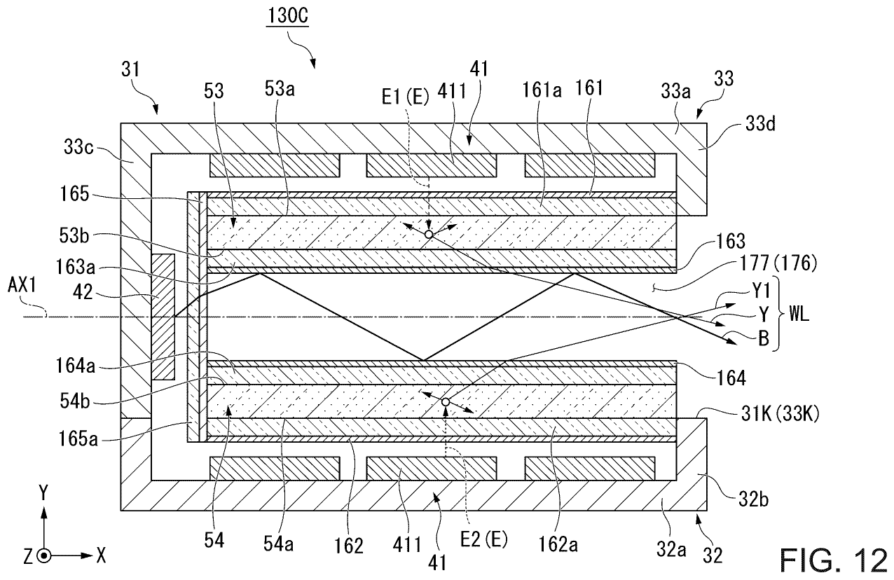

FIG. 12 is a cross-sectional view of the light source device 130C according to the seventh embodiment, cut along the XY plane. In FIG. 12, components common to those in the drawings used in the fourth embodiment are denoted by the same reference numerals, and their description will be omitted.

As shown in FIG. 12, a light source device 130C of the present embodiment includes the housing 31, the pair of first light sources 41, the first wavelength conversion element 53, the first optical layer 161, the light guide section 176, the second light source 42, the second wavelength conversion element 54, the second optical layer 162, the third optical layer 163, the fourth optical layer 164, the fifth optical layer 165, the translucent substrate 161a, a translucent substrate 162a, a translucent substrate 163a, a translucent substrate 164a, a first reflective member (not shown), and a second reflective member (not shown).

Other configuration of the light source device 130C is the same as the configuration obtained by a combination of the light source device 130A according to the fifth embodiment and the light source device 130B according to the sixth embodiment.

In the light source device 130 according to the fourth embodiment, the first optical layer 161 is provided on the upper surface 51a of the first wavelength conversion element 51, and the second optical layer 162 is provided on the upper surface 52a of the second wavelength conversion element 52. In contrast, in the light source device 130C according to the present embodiment, the translucent substrate 161a is disposed between the first optical layer 161 and the first wavelength conversion element 51, and the translucent substrate 162a is disposed between the second optical layer 162 and the second wavelength conversion element 52.

In the light source device 130 according to the fourth embodiment, the third optical layer 163 is provided on the lower surface 51b of the first wavelength conversion element 51, and the fourth optical layer 164 is provided on the lower surface 52b of the second wavelength conversion element 52. On the other hand, in the light source device 130C of the present embodiment, the translucent substrate 163a is disposed between the third optical layer 163 and the first wavelength conversion element 51, and the translucent substrate 164a is disposed between the second optical layer 162 and the second wavelength conversion element 52. The translucent substrates 161a to 164a are made of the same material as the first translucent member 73 of the first embodiment.

### Effects of the Seventh Embodiment

In the present embodiment also, the fluorescent light Y and Y1 propagates through the light guide section 176, and thus it is possible to obtain the same effects as those of the fourth embodiment, that is, it is possible to realize the light source device 130C with little loss of the fluorescent light Y and Y1 and excellent utilization efficiency of the fluorescent light Y and Y1 and it is possible to realize the light source device 130C in which the illumination light WL can be efficiently emitted.

The light source device 130C according to the present embodiment includes a first wavelength conversion element 53 and a second wavelength conversion element 54, each of which is configured from a phosphor with a light scattering property. The first wavelength conversion element 53 and the second wavelength conversion element 54, which are configured by a phosphor with a light scattering property, have low flatness on their upper surfaces 53a and 54a due to the provided uneven structure. For this reason, in a case where the first optical layer 61 and the second optical layer 62 are directly formed on the first wavelength conversion element 53 and the second wavelength conversion element 54, there is a concern that the flatness of the first optical layer 61 and the second optical layer 62 deteriorates, and the optical characteristics deteriorate.

On the other hand, in the light source device 130C of the present embodiment, the first optical layer 161, the second optical layer 162, the third optical layer 163, and the fourth optical layer 164 are formed on the respective translucent substrates 161a to 164a, allowing each of the optical layers 161 to 164 to be formed as a flat film, thereby improving the optical characteristics of each of the optical layers 161 to 164.

Therefore, even when the first wavelength conversion element 53 and the second wavelength conversion element 54, which are configured by a phosphor with light scattering property, are used in the light source device 130C according to the present embodiment, the optical layers 161 to 164 having excellent optical characteristics can be formed.

In the light source device 130C according to the present embodiment, heat from the first wavelength conversion element 53 is efficiently released through the translucent substrates 161a and 163a, and heat from the second wavelength conversion element 54 is efficiently released through the translucent substrates 162a and 164a. Therefore, the cooling performance of the first wavelength conversion element 53 and the second wavelength conversion element 54 is improved, the fluorescent light conversion efficiency of the first wavelength conversion element 53 and the second wavelength conversion element 54 is improved, and bright fluorescent light Y and Y1 can be generated.

The technical scope of the present disclosure is not limited to the above-described embodiment, and various modifications can be made without departing from the spirit of the present disclosure.

For example, a composite phosphor containing AlN and Ce:YAG may be used as the constituent material of the first wavelength conversion element. According to this configuration, even in a configuration where the contact areas between the first wavelength conversion elements and the housing are small and many heat dissipation paths cannot be secured, the thermal conductivity of the first wavelength conversion elements can be enhanced as compared with the case where a phosphor of Ce:YAG alone is used. By this, the cooling efficiency of the first wavelength conversion element is enhanced. By this, the maximum light amount of the first excitation light can be increased, and the maximum output of the yellow fluorescent light can be increased. Similarly, a composite phosphor may be used for the second wavelength conversion element.

In the above-described embodiment, the case where an LED is used as the second light source has been described as an example, but a laser light emitting element may be used. In this case, the laser light emitting element has a smaller emission angle than the LED, and the emitted light is transmitted through the inside of the light guide section as is. Therefore, in the first to third embodiments, the second optical layer provided between the first wavelength conversion element and the light guide section can be omitted. In the fourth to seventh embodiments, the third optical layer provided between the first wavelength conversion element and the light guide section and the fourth optical layer provided between the second wavelength conversion element and the light guide section can be omitted.

Furthermore, the specific descriptions of the shape, number, arrangement, material, and the like for each component of the light source device and the projector are not limited to the embodiment described above and can be appropriately modified. In the embodiments described above, the example in which the light source device according to the embodiment of the present disclosure is mounted on a projector that uses liquid crystal panels was described, but this is not a limitation. The light source device according to the embodiment of the present disclosure may be applied to a projector using a digital micromirror device as a light modulation device. The projector may not have multiple light modulation devices, or it may have only one light modulation device.

Although the embodiment has been described with an example in which the light source device according to the present disclosure is applied to a projector, this is not a limitation. The light source device of the present disclosure can also be applied to lighting fixtures, automobile headlights, and the like.

### SUMMARY OF THE PRESENT DISCLOSURE

Hereinafter, a summary of the present disclosure is appended.

### First Appendix

A light source device includes a first light source configured to emit first light of a first wavelength band; a first wavelength conversion element configured to convert the first light into second light in a second wavelength band different from the first wavelength band of the first light; a first optical layer that is disposed between the first light source and the first wavelength conversion element and that is configured to transmit the first light and reflect the second light; a second light source that emits third light in a third wavelength band different from the second wavelength band; and a light guide section that is disposed between the first wavelength conversion element and the first optical layer and that is configured to guide the second light converted by the first wavelength conversion element and the third light emitted from the second light source, wherein the first wavelength conversion element includes a first surface on which the first light is incident via the first optical layer, and a second surface and a third surface that intersect with the first surface and that face away from each other, the second light source is disposed in a region of the light guide section on the second surface side, the first optical layer reflects the third light emitted from the second light source in addition to reflecting the first light, and a portion of the second light converted by the first wavelength conversion element and of the third light emitted from the second light source travel through the light guide section and are emitted from a region on a third surface side of the light guide section.

According to the light source device having this configuration, a portion of the second light generated by the first wavelength conversion element and of the third light emitted from the second light source travels through the light guide section and is emitted from the region on the third surface side of the light guide section. Therefore, for example, compared to a related art light source device in which all the fluorescent light propagates inside the first wavelength conversion element, the loss of the second light is small, and it is possible to increase the utilization efficiency of the second light. Furthermore, the light source device with this configuration can efficiently emit illumination light in which the second light in the second wavelength band and the third light in the third wavelength band are combined.

### Second Appendix

The light source device according to the first appendix, further including a second optical layer disposed between the first wavelength conversion element and the light guide section, wherein the third wavelength of the third light is larger than the first wavelength of the first light, the second wavelength of the second light is larger than the third wavelength of the third light, and the second optical layer transmits the first light and the second light, and reflects the third light.

According to this configuration, the third light is reflected by the second optical layer, and thus it is possible to favorably propagate the third light within the light guide section. For example, by using yellow fluorescent light as the second light and blue light as the third light, white illumination light can be generated by combining the second light and the third light.

### Third Appendix

The light source device according to the second appendix, wherein the first wavelength conversion element is configured from a yellow phosphor having a light scattering property, the first light is a first blue light, the second light is a yellow fluorescent light, the third light is a second blue light, the fluorescent light propagates through the light guide section while repeatedly being scattered by the first wavelength conversion element and being reflected by the first optical layer, and is emitted from a region on the third surface side of the light guide section, and the second blue light propagates through the light guide section while repeatedly being reflected by the first optical layer and being reflected by the second optical layer, and is emitted from a region on the third surface side of the light guide section.

According to this configuration, the traveling direction of the second light changes to various directions due to the scattering of the light by the first wavelength conversion element, and the second light propagates through the inside of the light guide section and can be efficiently emitted from the region on the third surface side. Therefore, the loss of the second light is suppressed, and the extraction efficiency of the second light can be further enhanced. The white illumination light obtained by combining the yellow fluorescent light generated by the first wavelength conversion element and the second blue light emitted from the second light source can be efficiently extracted from the third surface side of the light guide section.

### Fourth Appendix

The light source device according to any one of first appendix to third appendix, further including a third optical layer that is disposed at least between the second light source and a region of the light guide section on the second surface side and that is configured to transmit the third light and to reflect the second light.

According to this configuration, by the second light reflecting and the third light being transmitted by the third optical layer, it is possible to efficiently emit the second light and the third light from the region on the third surface side of the light guide section.

### Fifth Appendix

The light source device according to any one of first appendix to the fourth appendix, further including a housing that accommodates the first optical layer and the first wavelength conversion element, wherein the housing has an extraction port out through which the second light and the third light are extracted and in plan view in the normal direction of the third surface of the first wavelength conversion element, the extraction port overlaps with the light guide section and the first wavelength conversion element.

According to this configuration, the first optical layer and the first wavelength conversion element can be protected by the housing, and light propagating through the inside of the light guide section can be extracted as illumination light out from the extraction port. Since the etendue of the illumination light is reduced, it is possible to reduce the loss of the illumination light in the optical member disposed at a subsequent stage of the light source device.

### Sixth Appendix

The light source device according to any one of the first appendix to the fifth appendix, wherein a first translucent member that transmits the first light, the second light, and the third light is disposed in the light guide section and a portion of the second light converted by the first wavelength conversion element and of the third light emitted from the second light source travels inside the first translucent member and is emitted from an end surface on the third surface side of the first translucent member.

According to this configuration, since the first translucent member is disposed in the light guide section, the refractive index difference between the first wavelength conversion element and the light guide section is smaller than that in a configuration in which the light guide section is formed of an air layer, and thus the critical angle at the interface between the first wavelength conversion element and the light guide section is smaller. By this, the second light generated by the first wavelength conversion element is more easily extracted to the light guide section, and thus it is possible to suppress loss due to reabsorption of the second light.

### Seventh Appendix

The light source device according to any one of the first appendix to the fifth appendix, wherein the light guide section is an air layer and the second light converted by the first wavelength conversion element and the third light emitted from the second light source travel through the air layer and are emitted from a region at the third surface side of the air layer.

According to this configuration, since the refractive index difference between the first wavelength conversion element and the light guide section is larger compared to the case where the second light is incident on a light guide section made of a translucent member, the second light travels in a direction that forms a smaller angle with respect to the longitudinal direction of the first wavelength conversion element. Since the region on the third surface side of the light guide section is open to the external air layer and thus there is no refractive index interface, the second light that reaches the region on the third surface side is emitted to the external space as is without being reflected or refracted. Therefore, the extraction efficiency of the second light can be enhanced.

### Eighth Appendix

The light source device according to any one of the first appendix to the seventh appendix, wherein a first reflective member and a second reflective member that reflect the first light, the second light, and the third light, wherein the first wavelength conversion element includes a fourth surface and a fifth surface that intersect the first surface, the second surface, and the third surface and that face away from each other, the first reflective member is disposed in a region at a fourth surface side of the light guide section, and the second reflective member is disposed in a region on a fifth surface side of the light guide section.

According to this configuration, the conversion efficiency from first light to second light can be enhanced by the first reflective member and the second reflective member. It is possible to suppress the loss of each light emitted from the fourth surface and the fifth surface and absorbed by the housing.

### Ninth Appendix

The light source device according to any one of the first appendix to the eighth appendix, wherein the first wavelength conversion element is configured from a transparent phosphor.

According to this configuration, even when a first wavelength conversion element formed of the transparent phosphor is used, the second light can be efficiently extracted out from the region on the third surface side of the light guide section.

### Tenth Appendix

The light source device according to any one of the first appendix to the eighth appendix, wherein the first wavelength conversion element is configured from a phosphor having a light scattering property.

According to this configuration, the traveling direction of the second light changes to various directions due to the scattering of the light by the first wavelength conversion element, and the second light can propagate through the inside of the light guide section and be efficiently emitted from the third surface side. Therefore, the loss of the second light is suppressed, and the extraction efficiency of the second light can be further enhanced.

### Eleventh Appendix

A light source device includes a first light source configured to emit first light of a first wavelength band; a first wavelength conversion element configured to convert the first light into second light in a second wavelength band different from the first wavelength band of the first light; a first optical layer that is disposed between the first light source and the first wavelength conversion element and that is configured to transmit the first light and reflect the second light; a light guide section that is disposed on an opposite side than the first optical layer with respect to the first wavelength conversion element and that guides incident light; a second wavelength conversion element that is disposed on an opposite side than the first wavelength conversion element with respect to the light guide section and that converts the first light incident through the first optical layer, the first wavelength conversion element, and the light guide section into a third light having a third wavelength band different from the first wavelength band; a second optical layer that is disposed at an opposite side than the light guide section with respect to the second wavelength conversion element and that reflects the second light and the third light; and a second light source that emits a fourth light having a fourth wavelength band different from the second wavelength band and the third wavelength band, wherein the first wavelength conversion element includes a first surface on which the first light is incident via the first optical layer, and a second surface and a third surface that intersect with the first surface and that face away from each other, the second light source is disposed in a region at a second surface side of the light guide section, the first optical layer and the second optical layer reflect the fourth light emitted from the second light source in addition to reflecting the second light and the third light, and a portion of the second light converted by the first wavelength conversion element, the third light converted by the second wavelength conversion element, and the fourth light emitted from the second light source travels through the light guide section and is emitted from a region at the third surface side of the light guide section.

According to the light source device having this configuration, the second light generated by the first wavelength conversion element, the third light generated by the second wavelength conversion element, and the fourth light emitted from the second light source travels through the light guide section and is emitted from the region on the third surface side of the light guide section. Therefore, for example, compared to the light source device in the related art in which all the fluorescent light propagates inside the wavelength conversion element, the loss of the second light and the third light is small, and it is possible to increase the use efficiency of the second light and the third light. Furthermore, the light source device with this configuration can efficiently emit the illumination light obtained by combining the second light, the third light, and the fourth light.

### Twelfth Appendix

The light source device according to the eleventh appendix, further including a third optical layer that is disposed between the first wavelength conversion element and the light guide section and that is configured to transmit the first light, the second light, and the third light, and to reflect the fourth light and a fourth optical layer that is disposed between the second wavelength conversion element and the light guide section and that is configured to transmit the first light, the second light, and the third light and to reflect the fourth light, wherein the fourth wavelength band of the fourth light is larger than the first wavelength band of the first light and the second wavelength band of the second light and the third wavelength band of the third light are larger than the fourth wavelength band of the fourth light.

According to this configuration, since the fourth light is reflected by the third optical layer and the fourth optical layer, it is possible to satisfactorily propagate the fourth light inside the light guide section. For example, by using yellow fluorescent light as the second light and the third light and using blue light as the fourth light, it is possible to generate white illumination light by combining the second light, the third light, and the fourth light.

### Thirteenth Appendix

The light source device according to the twelfth appendix, wherein the first wavelength conversion element and the second wavelength conversion element are configured from a yellow phosphor with a light scattering property, the first light is a first blue light, the second light and the third light are yellow fluorescent light, the fourth light is a second blue light, the fluorescent light propagates through the light guide section while repeatedly being at least one of being scattered by the first wavelength conversion element, being reflected by the first optical layer, being scattered by the second wavelength conversion element, and being reflected by the second optical layer, and is emitted from a region at the third surface side of the light guide section and the second blue light propagates through the light guide section while repeatedly being reflected by the third optical layer and being reflected by the fourth optical layer, and is emitted from a region on the third surface side of the light guide section.

According to this configuration, the traveling directions of the second light and the third light are changed to various directions by the scattering of the light by the respective wavelength conversion elements, and the second light and the third light can propagate through the inside of the light guide section and be efficiently emitted from the region on the third surface side. Therefore, the loss of the second light and the third light is suppressed, and the extraction efficiency of the second light and the third light can be further enhanced. White illumination light obtained by combining the yellow fluorescent light generated by the first wavelength conversion element and the second wavelength conversion element with the second blue light emitted from the second light source can be efficiently extracted from the third surface side of the light guide section.

### Fourteenth Appendix

The light source device according to any one of the eleventh appendix to the thirteenth appendix, further including a fifth optical layer that is disposed at least between the second light source and a region at the second surface side of the light guide section and that is configured to transmit the fourth light and to reflect the second light and the third light.

According to this configuration, since the second light and the third light and the fourth light is transmitted, by the fifth optical layer, it is possible to efficiently emit the second light, the third light, and the fourth light from the region on the third surface side of the light guide section.

### Fifteenth Appendix

The light source device according to any one of the eleventh appendix to the fourteenth appendix, further including a housing that accommodates the first optical layer, the second optical layer, the first wavelength conversion element, and the second wavelength conversion element, wherein the housing includes an extraction port out through which the second light, the third light, and the fourth light emitted from the region on the third surface side of the light guide section are extracted and in plan view in a normal direction of the third surface of the first wavelength conversion element, the extraction port overlaps the light guide section, the first wavelength conversion element, and the second wavelength conversion element.

According to this configuration, the first optical layer, the second optical layer, the first wavelength conversion element, and the second wavelength conversion element can be protected by the housing, and light propagating inside the light guide section can be extracted as illumination light out from the extraction port. Since the etendue of the illumination light is reduced, it is possible to reduce the loss of the illumination light in the optical member disposed at a subsequent stage of the light source device.

### Sixteenth Appendix

The light source device according to any one of the eleventh appendix to the fifteenth appendix, wherein a first translucent member that transmits the first light, the second light, the third light, and the fourth light is disposed in the light guide section and a portion of the second light converted by the first wavelength conversion element, the third light converted by the second wavelength conversion element, and the fourth light emitted from the second light source travels inside the first translucent member and is emitted from an end surface at the third surface side of the first translucent member.

According to this configuration, since the first translucent member is disposed in the light guide section, the refractive index difference between each wavelength conversion element and the light guide section is smaller than in a configuration in which the light guide section is formed of an air layer, and thus the critical angle at the interface between each wavelength conversion element and the light guide section is smaller. By this, the second light and the third light generated by the respective wavelength conversion elements can be easily extracted to the light guide section, and loss due to reabsorption of the second light and the third light can be suppressed.

### Seventeenth Appendix

The light source device according to any one of the eleventh appendix to the sixteenth appendix, wherein the light guide section is an air layer and the second light converted by the first wavelength conversion element, the third light converted by the second wavelength conversion element, and the fourth light emitted from the second light source travel through the air layer and are emitted from a region at the third surface side of the air layer.

According to this configuration, since the refractive index difference between each wavelength conversion element and the light guide section is larger than that in a case where the second light and the third light is incident on the light guide section formed of a translucent member, the second light and the third light travel in a direction forming a small angle with respect to the longitudinal direction of each wavelength conversion element. Since the region of the light guide section on the third surface side is opened to an external air layer, resulting in no refractive index interface, the second light and the third light that reaches the region on the third surface side is emitted to the external space as is without being reflected or refracted. Therefore, the extraction efficiency of the second light and the third light can be enhanced.

### Eighteenth Appendix

The light source device according to any one of the eleventh appendix to the seventeenth appendix, further including a first reflective member and a second reflective member that reflect the first light, the second light, the third light, and the fourth light, wherein the first wavelength conversion element includes a fourth surface and a fifth surface that intersect the first surface, the second surface, and the third surface and that face away from each other, the first reflective member is disposed in a region at a fourth surface side of the light guide section, and the second reflective member is disposed in a region on a fifth surface side of the light guide section.

According to this configuration, the conversion efficiency from the first light to the second light and the conversion efficiency from the first light to the third light can be enhanced by the first reflective member and the second reflective member. It is possible to suppress the loss of each light emitted from the fourth surface and the fifth surface and absorbed by the housing.

### Nineteenth Appendix

The light source device according to any one of the eleventh appendix to the eighteenth appendix, wherein the first wavelength conversion element and the second wavelength conversion element are configured from a transparent phosphor.

According to this configuration, even when a first wavelength conversion element and a second wavelength conversion element configured by a transparent phosphor are used, the second light and the third light can be efficiently extracted out from the region on the third surface side of the light guide section.

### Twentieth Appendix

The light source device according to any one of the eleventh appendix to the eighteenth appendix, wherein the first wavelength conversion element and the second wavelength conversion element are configured from a phosphor having a light scattering property.

According to this configuration, the traveling directions of the second light and the third light are changed to various directions by the scattering of the light by the wavelength conversion element, and the second light and the third light can be efficiently emitted from the third surface by propagating through the inside of the light guide section. Therefore, the loss of the second light and the third light is suppressed, and the extraction efficiency of the second light and the third light can be further enhanced.

### Twenty-First Appendix

A projector including the light source device according to any one of the first appendix to the twentieth appendix; a light modulation device that modulates the light emitted from the light source device; and a projection optical device that projects the light modulated by the light modulation device.

According to the projector having this configuration, since the light source device that efficiently extracts light is provided, it is possible to provide a projector with excellent light utilization efficiency.

What is claimed is:

1. A light source device comprising:
a first light source configured to emit first light of a first wavelength band;
a first wavelength conversion element configured to convert the first light into second light in a second wavelength band different from the first wavelength band of the first light;
a first optical layer that is disposed between the first light source and the first wavelength conversion element and that is configured to transmit the first light and reflect the second light;
a second light source that emits third light in a third wavelength band different from the second wavelength band; and
a light guide section that is disposed between the first wavelength conversion element and the first optical layer and that is configured to guide the second light converted by the first wavelength conversion element and the third light emitted from the second light source, wherein
the first wavelength conversion element includes a first surface on which the first light is incident via the first optical layer, and a second surface and a third surface that intersect with the first surface and that face away from each other,
the second light source is disposed in a region at a second surface side of the light guide section,
the first optical layer reflects the third light emitted from the second light source in addition to reflecting the first light, and
a portion of the second light converted by the first wavelength conversion element and of the third light emitted from the second light source travel through the light guide section and are emitted from a region on a third surface side of the light guide section.

2. The light source device according to claim 1, further comprising:
a second optical layer disposed between the first wavelength conversion element and the light guide section, wherein
the third wavelength band of the third light is larger than the first wavelength band of the first light,
the second wavelength band of the second light is larger than the third wavelength band of the third light, and
the second optical layer transmits the first light and the second light, and reflects the third light.

3. The light source device according to claim 2, wherein
the first wavelength conversion element is configured from a yellow phosphor having a light scattering property,
the first light is a first blue light,
the second light is a yellow fluorescent light,
the third light is a second blue light,
the fluorescent light propagates through the light guide section while repeatedly being scattered by the first wavelength conversion element and being reflected by the first optical layer, and is emitted from a region on the third surface side of the light guide section, and
the second blue light propagates through the light guide section while repeatedly being reflected by the first optical layer and being reflected by the second optical layer, and is emitted from a region on the third surface side of the light guide section.

4. The light source device according to claim 1, further comprising:
a third optical layer that is disposed at least between the second light source and a region of the light guide section on the second surface side and that is configured to transmit the third light and to reflect the second light.

5. The light source device according to claim 1, further comprising:
a housing that accommodates the first optical layer and the first wavelength conversion element, wherein
the housing has an extraction port out through which the second light and the third light are extracted and
in plan view in the normal direction of the third surface of the first wavelength conversion element, the extraction port overlaps with the light guide section and the first wavelength conversion element.

6. The light source device according to claim 1, wherein
a first translucent member that transmits the first light, the second light, and the third light is disposed in the light guide section and
a portion of the second light converted by the first wavelength conversion element and of the third light emitted from the second light source travels inside the first translucent member and is emitted from an end surface on the third surface side of the first translucent member.

7. The light source device according to claim 1, wherein
the light guide section is an air layer and
the second light converted by the first wavelength conversion element and the third light emitted from the second light source travel through the air layer and are emitted from a region at the third surface side of the air layer.

8. The light source device according to claim 1, further comprising:
a first reflective member and a second reflective member that reflect the first light, the second light, and the third light, wherein
the first wavelength conversion element includes a fourth surface and a fifth surface that intersect the first surface, the second surface, and the third surface and that face away from each other,
the first reflective member is disposed in a region at a fourth surface side of the light guide section, and
the second reflective member is disposed in a region on a fifth surface side of the light guide section.

9. The light source device according to claim 1, wherein
the first wavelength conversion element is configured from a transparent phosphor.

10. The light source device according to claim 1, wherein
the first wavelength conversion element is configured from a phosphor having a light scattering property.

11. A light source device comprising:
a first light source configured to emit first light of a first wavelength band;
a first wavelength conversion element configured to convert the first light into second light in a second wavelength band different from the first wavelength band of the first light;
a first optical layer that is disposed between the first light source and the first wavelength conversion element and that is configured to transmit the first light and reflect the second light;
a light guide section that is disposed on an opposite side than the first optical layer with respect to the first wavelength conversion element and that guides incident light;
a second wavelength conversion element that is disposed on an opposite side than the first wavelength conversion element with respect to the light guide section and that converts the first light incident through the first optical layer, the first wavelength conversion element, and the light guide section into a third light having a third wavelength band different from the first wavelength band;
a second optical layer that is disposed at an opposite side than the light guide section with respect to the second wavelength conversion element and that reflects the second light and the third light; and
a second light source that emits a fourth light having a fourth wavelength band different from the second wavelength band and the third wavelength band, wherein
the first wavelength conversion element includes a first surface on which the first light is incident via the first optical layer, and a second surface and a third surface that intersect with the first surface and that face away from each other,
the second light source is disposed in a region at a second surface side of the light guide section,
the first optical layer and the second optical layer reflect the fourth light emitted from the second light source in addition to reflecting the second light and the third light, and
a portion of the second light converted by the first wavelength conversion element, the third light converted by the second wavelength conversion element, and the fourth light emitted from the second light source travels through the light guide section and is emitted from a region at the third surface side of the light guide section.

12. The light source device according to claim 11, further comprising:
a third optical layer that is disposed between the first wavelength conversion element and the light guide section and that is configured to transmit the first light, the second light, and the third light, and to reflect the fourth light and
a fourth optical layer that is disposed between the second wavelength conversion element and the light guide section and that is configured to transmit the first light, the second light, and the third light and to reflect the fourth light, wherein
the fourth wavelength band of the fourth light is larger than the first wavelength band of the first light and
the second wavelength band of the second light and the third wavelength band of the third light are larger than the fourth wavelength band of the fourth light.

13. The light source device according to claim 12, wherein
the first wavelength conversion element and the second wavelength conversion element are configured from a yellow phosphor with a light scattering property,
the first light is a first blue light,
the second light and the third light are yellow fluorescent light,
the fourth light is a second blue light,
the fluorescent light propagates through the light guide section while repeatedly being at least one of being scattered by the first wavelength conversion element, being reflected by the first optical layer, being scattered by the second wavelength conversion element, and being reflected by the second optical layer, and is emitted from a region at the third surface side of the light guide section and
the second blue light propagates through the light guide section while repeatedly being reflected by the third optical layer and being reflected by the fourth optical layer, and is emitted from a region on the third surface side of the light guide section.

14. The light source device according to claim 11, further comprising:
a fifth optical layer that is disposed at least between the second light source and a region at the second surface side of the light guide section and that is configured to transmit the fourth light and to reflect the second light and the third light.

15. The light source device according to claim 11, further comprising:
a housing that accommodates the first optical layer, the second optical layer, the first wavelength conversion element, and the second wavelength conversion element, wherein
the housing includes an extraction port out through which the second light, the third light, and the fourth light emitted from the region on the third surface side of the light guide section are extracted and
in plan view in a normal direction of the third surface of the first wavelength conversion element, the extraction port overlaps the light guide section, the first wavelength conversion element, and the second wavelength conversion element.

16. The light source device according to claim 11, wherein
a first translucent member that transmits the first light, the second light, the third light, and the fourth light is disposed in the light guide section and
a portion of the second light converted by the first wavelength conversion element, the third light converted by the second wavelength conversion element, and the fourth light emitted from the second light source travels inside the first translucent member and is emitted from an end surface at the third surface side of the first translucent member.

17. The light source device according to claim 11, wherein
the light guide section is an air layer and
the second light converted by the first wavelength conversion element, the third light converted by the second wavelength conversion element, and the fourth light emitted from the second light source travel through the air layer and are emitted from a region at the third surface side of the air layer.

18. The light source device according to claim 11, further comprising:
a first reflective member and a second reflective member that reflect the first light, the second light, the third light, and the fourth light, wherein
the first wavelength conversion element includes a fourth surface and a fifth surface that intersect the first surface, the second surface, and the third surface and that face away from each other,
the first reflective member is disposed in a region at a fourth surface side of the light guide section, and
the second reflective member is disposed in a region on a fifth surface side of the light guide section.

19. The light source device according to claim 11, wherein
the first wavelength conversion element and the second wavelength conversion element are configured from a transparent phosphor.

20. The light source device according to claim 11, wherein
the first wavelength conversion element and the second wavelength conversion element are configured from a phosphor having a light scattering property.

21. A projector comprising:
the light source device according to claim 1;
a light modulation device that modulates the light emitted from the light source device; and
a projection optical device that projects the light modulated by the light modulation device.

22. A projector comprising:
the light source device according to claim 11;
a light modulation device that modulates the light emitted from the light source device; and
a projection optical device that projects the light modulated by the light modulation device.
